(19) United States
(12) Patent Application Publication
(10) Pub. No.: US 2016/0285949 A1
(43) Pub. Date: Sep. 29, 2016

(54) WIRELESS LOGIN-BASED REMOTE CONTROL METHOD AND DEVICE

(71) Applicant: LE SHI ZHI XIN ELECTRONIC TECHNOLOGY (TIANJIN) LIMITED, Beijing (CN)

(72) Inventors: Pengfei LI, Beijing (CN); Fan LIANG, Beijing (CN); Zhen LI, Beijing (CN)

(21) Appl. No.: 15/033,595

(22) PCT Filed: Oct. 30, 2014
(86) PCT No.: PCT/CN2014/089929

§ 371 Date: Apr. 29, 2016

(30) Foreign Application Priority Data
Oct. 30, 2013 (CN) 201310530238.0
Oct. 30, 2013 (CN) 201310530240.8
Oct. 30, 2013 (CN) 201310530268.1

(51) Int. Cl. H04L 29/08; H04W 8/00; H04L 29/06; H04W 12/08

(52) U.S. Cl. CPC H04L 67/025; H04W 12/08; H04W 8/005; H04L 67/42

(57) ABSTRACT

A remote control method based on wireless login, including the following steps that after a first electronic device detects a second electronic device located in the same local area network with the first electronic device and meets preset conditions in the local area network, the first electronic device obtains the information of the second electronic device. According to the physical address in the information of the second electronic device, a communication channel with the second electronic device is built, and then a control instruction is sent to the second electronic device through the communication channel to control the second electronic device to execute the control instruction. Therefore, the first electronic device and the second electronic devices in the present disclosure establish communication channels for network connections through a local area network. Through the communication channels, mutual control can be implemented between the first electronic device and the second electronic devices.

The present disclosure is a national stage of International Application No. PCT/CN2014/089929, filed Oct. 30, 2014, which claims the priority to the Chinese Patent Application No. 201310530240.8 titled “wireless login-based remote control method and device” filed the Chinese Patent Office on Oct. 30, 2013; Chinese Patent Application No. 201310530268.1 titled “Remote control method and device based on account number log-in” filed the Chinese Patent Office on Oct. 30, 2013; and Chinese Patent Application No. 201310530238.0 titled “Equipment interconnection method and device” filed the Chinese Patent Office on Oct. 30, 2013, which are hereby incorporated herein by reference in their entirety.

### FIELD OF TECHNOLOGY

The present disclosure relates to the control field of the communication technology controlling field and, more particularly, to a remote control method and device based on wireless login.

### BACKGROUND

With the rise of the Internet, intelligent control among the electronic devices through internet has become an increasingly growing trend for control technology. In the field of remote control technology, it has become the main direction in the development of remote control technology to establish communication connections among different electronic devices, so as to implement mutual control between different electronic devices.

In the present field of remote control technology, the remote control manner between the remote control device and the device being remotely controlled is to request the pre-configuration between the remote control device and the device being remotely controlled. Such configuration satisfies the communication connections between the remote control device and the device being remotely controlled, and then the remote control device remotely controls the device being remotely controlled to execute the remote control action.

Therefore, the remote control manner in the prior art can only implement mutual control between preconfigured paired electronic devices, and the unpaired electronic devices cannot achieve mutual control.

### SUMMARY

With respect to the above problem, the present disclosure provides a remote control method and device based on wireless login to solve the problem that the remote control manner in the prior art can only implement mutual control between preconfigured paired electronic devices, and the unpaired electronic devices cannot achieve mutual control.

The technical solutions are:

Based on an aspect of the present disclosure, there is provided a remote control method based on wireless login applied to a first electronic device, characterized in that, the method includes:

after obtaining an operation instruction, judging whether the first electronic device is connected to a network;

when judging that the first electronic device is connected to the network, detecting second electronic devices that are located in the same network as the first electronic device and meet a preset condition;

when detecting the second electronic devices that meet the preset condition, determining at least one second electronic device as a target electronic device; and

sending a control instruction to the target electronic device, wherein the control instruction is used for controlling the target electronic device to execute the control instruction.

In an embodiment of the present disclosure,

said after obtaining an operation instruction, judging whether the first electronic device is connected to a network is: after obtaining an operation instruction, judging whether the first electronic device is connected to a local area network;

said when judging that the first electronic device is connected to the network, detecting second electronic devices that are located in the same network as the first electronic device and meet a preset condition is: when judging that the first electronic device is connected to the local area network, detecting the second electronic devices that are located in the same local area network as the first electronic device and meet a preset condition; when judging that the first electronic device is not connected to the local area network, prompting whether the first electronic device is connected to the local area network, connecting to the local area network after receiving the confirmation instruction to connect to the local area network, and detecting the second electronic devices that are located in the same local area network as the first electronic device and meet a preset condition when the first electronic device and the local area network are in a connecting state;

when detecting the second electronic devices that meet the preset condition, determining at least one second electronic device as a target electronic device is: when detecting the second electronic devices that are located in the same local area network as the first electronic device and meet a preset condition, obtaining the information of the second electronic device; wherein the information of the second electronic device at least includes the physical address of the second electronic device;

according to the physical address of the second electronic device, building a first communication channel with the second electronic device;

said sending a control instruction to the target electronic device, wherein the control instruction is used for controlling the target electronic device to execute the control instruction is: sending a control instruction to the second electronic device through the first communication channel, so as to control the second electronic device to execute the control instruction.

In an embodiment of the present disclosure, said detecting second electronic devices that are located in the same local area network as the first electronic device and meet a preset condition includes:

detecting the electronic devices that are located in the same local area network as the first electronic device, judging whether the detected electronic device is a Universal Plug-n-Play (UPNP) device having a preset label, and obtaining a first judging result;

when the first judging result shows that the electronic device is a Universal Plug-n-Play (UPNP) device, determining that the second electronic devices which meet a preset condition are detected.

In an embodiment of the present disclosure, said prompting whether the first electronic device is connected to the local area network includes:

popping up a first prompt message for prompting the user to select whether to connect to the local area network.

In an embodiment of the present disclosure, when the first electronic device is connected to the local area network, the method further includes:

when it is unable to obtain the information of the second electronic devices that are located in the same local area network as the first electronic device and meet a preset condition within a preset time, popping up a second prompt message for prompting the user to select whether to redetect the second electronic devices that are located in the same local area network as the first electronic device and meet a preset condition;

when the user selects to redetect the second electronic devices that are located in the same local area network as the first electronic device and meet a preset condition according to the second prompt message, the first electronic device redetects the second electronic devices that are located in the same local area network as the first electronic device and meet a preset condition.

In an embodiment of the present disclosure, when the first electronic device is connected to the local area network, the method further includes:

real-time monitoring the connection state between the local area network and the first electronic device, and popping up a third prompt message when the connection state between the local area network and the first electronic device is changed; wherein the third prompt message is used for prompting the user that the connection state between the present local area network and the first electronic device is changed.

In an embodiment of the present disclosure, said obtaining the information of the second electronic devices that are located in the same local area network as the first electronic device and meet a preset condition includes:

receiving a first device information list includes the information of the second electronic devices that are located in the same local area network as the first electronic device and meet a preset condition;

obtaining the information of the second electronic devices that are located in the same local area network as the first electronic device and meet a preset condition according to the first device information list.

In an embodiment of the present disclosure, said after obtaining the information of the second electronic devices that are located in the same local area network as the first electronic device and meet a preset condition further includes

sending an update instruction to the local area network, wherein the update instruction is used for redetecting the second electronic devices that are located in the same local area network as the first electronic device and meet a preset condition;

receiving the second device information list includes the re-detected information of the second electronic devices that are located in the same local area network as the first electronic device and meet a preset condition.

In an embodiment of the present disclosure, after obtaining an operation instruction, judging whether the first electronic device is connected to a network is: after obtaining an operation instruction, judging whether the first electronic device is connected to a server;

said when determining that the first electronic device is connected to the network, detecting second electronic devices that are located in the same network as the first electronic device and meet a preset condition is: when the first electronic device is connected to a server, sending account information includes the physical address of the first electronic device to the server; wherein the physical address of the first electronic device is used for building a first communication channel between the first electronic device and the server according to the physical address of the first electronic device, after the sever receives the physical address of the first electronic device;

receiving the information of the second electronic device that is sent by the server using the first communication channel and logs on to the server using the same account information; wherein, the information of the second electronic device at least includes the physical address of the second electronic device;

said when detecting the second electronic devices that meet the preset condition, determining at least one second electronic device as a target electronic device is: determining at least one of the second electronic devices that log on to the server as the target electronic device;

said sending a control instruction to the target electronic device, wherein the control instruction is used for controlling the target electronic device to execute the control instruction is: sending a control information to the server, wherein the control information at least includes the information of the target electronic device and the first control instruction;

wherein, the information of the target electronic device includes the physical address of the target electronic device, wherein the physical address of the target electronic device is used for building a second communication channel between the target electronic device and the server according to the physical address of the target electronic device, after the sever receives the physical address of the target electronic device, sending the first control instruction sent by the first electronic device to the target electronic device using the second communication channel; the first control instruction is used for executing the first control instruction after the target electronic device receives the control instruction.

In an embodiment of the present disclosure, the method further includes receiving a device list sent by the server, wherein the device list includes the information of all the second electronic devices that log on under the same account information.

In an embodiment of the present disclosure, the method further includes:

sending instruction information to the server for prompting the server to control the target electronic device to start a data reception mode;

receiving the confirmation instruction returned from the server, wherein the confirmation instruction is used for informing the first electronic device that the target electronic device starts the data reception mode;

sending data information to the server using the first communication channel built between the first electronic device and the server, so as to make the server send the data information to the target electronic device after receiving the data information, to make the target electronic device output the data information.

In an embodiment of the present disclosure, the method further includes:

receiving the second control instruction sent by the server through the first communication channel, wherein the second control instruction is sent by the second electronic device to the server;

executing the second control instruction.

The present disclosure further discloses a remote control method based on wireless login applied to a first electronic device, characterized in that, the method includes:

after obtaining an operation instruction, judging whether the first electronic device is connected to a local area network;

when judging that the first electronic device is connected to the local area network, detecting second electronic devices that are located in the same local area network as the first electronic device and meet a preset condition;

when judging that the first electronic device is not connected to the local area network, making the first electronic device log on to a server using an account number, to detect second electronic devices that are under the account number as the first electronic device;

determining at least one second electronic device as a target electronic device among the detected second electronic devices that are located in the same local area network as the first electronic device and meet a preset condition or the detected second electronic devices that are under the same account number as the first electronic device;

sending a control instruction to the target electronic device, wherein the control instruction is used for controlling the target electronic device to execute the control instruction.

In an embodiment of the present disclosure, said prompting the user to log on using account number, to detect second electronic devices that are under the account number as the first electronic device includes:

popping up a fourth prompt message for prompting the user whether to select account number log-in;

when the user selects the account number log-in, receiving the account number inputted by the user and sending account number information to the server;

receiving the information of the second electronic device that is sent and detected by the server and logs on to the server using the same account number information;

detecting the second electronic devices that are under the same account number as the first electronic device according to the information of the second electronic message;

wherein, said sending control instruction to the target electronic device includes:

sending control instruction to the server, to make the server send the control instruction to the target electronic device to control the target electronic device to execute the control instruction.

In an embodiment of the present disclosure, when the first electronic device logs on to the server using the account number information, after the sending control instruction to the server, the method further includes:

receiving a fifth prompt message sent by the server, wherein the fifty prompt message is used for prompting the user whether to select to remember the account number information;

when the user selects to remember the account number information according to the fifth prompt message, the first electronic device storing the account number information;

when the user selects the account number log-in again, sending the stored account number information to the server.

In an embodiment of the present disclosure, the user making the account number log-in to detect the second electronic devices that are under the same account number as the first electronic device includes:

sending account number information to the server, wherein the account number information includes the physical address of the first electronic device; wherein the physical address of the first electronic device is used for building a second communication channel between the first electronic device and the server according to the physical address of the first electronic device, after the sever receives the physical address of the first electronic device;

receiving the information of the second electronic devices that is sent by the server using the second communication channel and logs on to the server under the same account number information; wherein the information of the second electronic device at least includes the physical address of the second electronic device;

sending control information to the server, wherein the control information at least includes the information of the target electronic device and the first control instruction;

wherein, the information of the target electronic device includes the physical address of the target electronic device, wherein the physical address of the target electronic device is used for building a third communication channel between the target electronic device and the server according to the physical address of the target electronic device, after the sever receives the physical address of the target electronic device, sending the first control instruction sent by the first electronic device to the target electronic device using the third communication channel; wherein the first electronic instruction is used for executing the first control instruction after the target electronic device receives the control instruction.

In an embodiment of the present disclosure, said receiving the information of the second electronic devices that is sent by the server using the second communication channel and logs on to the server under the same account number information includes:

receiving the device list sent by the server, wherein the device list includes the information of all the second electronic devices that log on under the same account information.

In an embodiment of the present disclosure, the method further includes:

sending instruction information to the server for prompting the server to control the target electronic device to start the data reception mode;

receiving a confirmation instruction returned from the server, wherein the confirmation instruction is used for informing the first electronic device that the target electronic device starts the data reception mode;

sending data information to the server using the second communication channel built between the first electronic device and the server, so as to make the server send the data information to the target electronic device after receiving the data information and make the target electronic device output the data information.

In an embodiment of the present disclosure, the method further includes:

receiving a second control instruction sent by the server through the second communication channel, wherein the second control instruction is sent by the second electronic device to the server;

executing the second control instruction.

Based on another aspect of the present disclosure, the present disclosure further discloses a remote control device based on wireless login applied to a first electronic device, characterized in that, the device includes:

a first acquisition module configured to acquire operation instruction;

a judging module configured to judge whether the first electronic device is connected to a network;

a detecting module configured to detect second electronic devices that are located in the same network as the first electronic device and meet a preset condition, when judging that the first electronic device is connected to the network;

a determining module configured to determine at least one second electronic device as a target electronic device, when detecting the second electronic devices that meet the preset condition;

a sending module configured to send control instruction to the target electronic device, wherein the control instruction is used for controlling the target electronic device to execute the control instruction.

In an embodiment of the present disclosure, the device includes a first acquisition module, configured to obtain the operation instruction, the judging module is configured to judge whether the first electronic device is connected to a local area network, after the first acquisition module obtains an operation instruction;

the detecting module is configured to detect second electronic devices that are located in the same local area network as the first electronic device and meet a preset condition, when the first electronic device is connected to a local area network;

a first prompt module is configured to prompt the first electronic device whether to connect to the local area network when the first electronic device is not connected to the local area network;

a first reception module is configured to receive confirmation instruction to connect to the local area network;

a linking module is configured to connect to the local area network after the first reception module receives confirmation instruction to connect to the local area network;

wherein, the detecting module is configured to detect second electronic devices that are located in the same local area network as the first electronic device and meet a preset condition, after the linking module is connected to the local area network;

the determining module includes a second acquisition module configured to acquire the information of the second electronic devices that are located in the same local area network as the first electronic device and meet a preset condition; wherein the information of the second electronic device at least includes the physical address of the second electronic device;

the determining module further includes a building module of the first communication channel configured to establish the first communication channel with the second electronic device according to the physical address of the second electronic device;

the sending module configured as a first sending module that sends control instruction to the second electronic device through the first communication channel, to control the second electronic devices to execute the control instruction.

In an embodiment of the present disclosure, the detecting module includes:

a device detection module, is set to detect an electronic device that is on the same LAN with the first electronic device.

a result judgment module, is set to judge whether the electronic device detected by the device detection module is an UPNP (universal plug and play) device with the pre-set logo, and then obtain first judgment result.

a device determination module, is set to determine the detected second electronic device that conforms with the precondition when the first judgment result shows that the electronic device is UPNP.

In an embodiment of the present disclosure, the first prompting module is used to prompt the user to select whether connect to LAN.

In an embodiment of the present disclosure, there further include:

a second prompt module configured to pop up a second prompt message when the second acquisition module is unable to obtain the information of the second electronic devices that are located in the same local area network as the first electronic device and meet a preset condition within the preset time, wherein the second prompt message is configured to prompt the user to select whether to redetect the second electronic devices that are located in the same local area network as the first electronic device and meet a preset condition;

when the user selects to redetect the second electronic devices that are located in the same local area network as the first electronic device and meet a preset condition according to the second prompt message, the first electronic device redetects the second electronic devices that are located in the same local area network as the first electronic device and meet a preset condition.

In an embodiment of the present disclosure, further includes:

a monitoring module configured to monitor the connection state between the local area network and the first electronic device in real time;

a third prompt module configured to pop up a third prompt message when the connection state monitored by the monitoring module between the local area network and the first electronic device is changed; the third prompt message configured to prompt the user that the connection state between the local area network and the first electronic device is changed.

In an embodiment of the present disclosure, the second acquisition module includes:

an information receiving module, is set to receive an information list of the first device that includes the information of the second electronic device that is on the same LAN with the first electronic device and meets the preconditions.

an information acquisition module, is set to obtain the information of the second electronic device that is on the same LAN with the first electronic device and meets the preconditions according to the information list of the first device.

In an embodiment of the present disclosure, further includes:

a second sending module, is set to send a refresh instruction to the LAN. The refresh instruction is used to detect afresh the second electronic device that is on the same LAN with the first electronic device and meets the preconditions.

a second receiving module, is set to receive an information list of a second device. The information list of the second device includes the information of the second electronic device that is detected afresh and is on the same LAN with the first electronic device and meets the preconditions.

In an embodiment of the present disclosure, the device further includes:

the judging module further configured to judge whether the first electronic device is connected to the server;

a first information sending module configured to send account number information to the server. Wherein the account information includes the physical address of the first electronic device;

the physical address of the first electronic device configured to build a first communication channel between the first electronic device and the server according to the physical address of the first electronic device, after the server receives the physical address of the first electronic device;

a first information sending module configured to receive the information of the second electronic devices that is sent by the server using the first communication channel and logs on to the server using the same account number information. Wherein, the information of the second electronic device at least includes the physical address of the second electronic device;

a login determining module configured to determine at least one of the second electronic devices that log on to the server as the target electronic device;

a second information sending module configured to send control information to the server, wherein the control information at least includes the information of the target electronic device and the first control instruction;

wherein, the information of the target electronic device at least includes the physical address of the target electronic device, wherein the physical address of the target electronic device is used for establishing a second communication channel between the target electronic device and the server according to the physical address of the target electronic device, after the server receives the physical address of the target electronic device, sending the first control instruction sent by the first electronic device to the target electronic device using the second communication channel. The first control instruction is used for executing the first control instruction after the target electronic device receives the first control instruction.

The present disclosure further discloses a remote control device based on wireless login applied to a first electronic device, characterized in includes:

a first acquisition module configured to acquire operation instruction;

a judging module configured to judge whether the first electronic device is connected to a local area network, after the first acquisition module acquires operation instruction;

a local area network detecting module configured to detect second electronic devices that are located in the same local area network as the first electronic device and meet a preset condition, when the judging module judging that the first electronic device is connected to the local area network;

a login prompt module configured to make the first electronic device log on to the server using account number, when the judging module judging that the first electronic device is not connected to the local area network;

an account detecting module configured to detect the second electronic devices that log on under the same account information as the first electronic device, after the user making the account log-in;

a target determination module configured to determine at least one second electronic device as the target electronic device among the second electronic devices that are detected by the first detecting module, located in the same network as the first electronic device and meet a preset condition; or among the second electronic devices that are detected by the second detecting module and located in the same network as the first electronic device

an instruction sending module configured to send control instruction to the target electronic device, wherein the control instruction is used for controlling the target electronic device to execute the control instruction.

In an embodiment of the present disclosure, the login prompt module includes:

a first information sending module configured to send account information to the server. Wherein, the account information includes the physical address of the first electronic device;

the physical address of the first electronic device configured to establish the first communication channel between the first electronic device and the server according to the physical address of the first electronic device, after the server receives the physical address of the first electronic device,

a first information reception module configured to receive the information of the second electronic device that is sent by the server using the first communication channel and logs on to the server using the same account information; wherein, the information of the second electronic device at least includes the physical address of the second electronic device;

a login determining module configured to determine at least one of the second electronic devices that log on to the server as the target electronic device;

a second information sending module configured to send control information to the server, wherein the control information at least includes the information of the target electronic device and the first control instruction;

wherein, the information of the target electronic device comprises the physical address of the target electronic device, wherein the physical address of the target electronic device is used for establishing the second communication channel between the target electronic device and the server according to the physical address of the target electronic device, after the server receives the physical address of the target electronic device, sending the first control instruction sent by the first electronic device to the target electronic device using the second communication channel. The first control instruction is used for executing the first control instruction after the target electronic device receives the first control instruction.

According to still another aspect of the present disclosure, there is provided a non-transitory computer readable medium, having computer programs stored thereon that, when executed by one or more processors of an electronic device, cause the electronic device to perform:

after obtaining an operation instruction, judging whether the first electronic device is connected to a network;

when judging that the first electronic device is connected to the network, detecting second electronic devices that are located in the same network as the first electronic device and meet a preset condition;

when detecting the second electronic devices that meet the preset condition, determining at least one second electronic device as a target electronic device; and

sending a control instruction to the target electronic device, wherein the control instruction is used for controlling the target electronic device to execute the control instruction.

There is further provided a first electronic device based on wireless login, characterized in that, the device includes:

a memory having instructions stored thereon;

a processor configured to execute the instructions to perform remote controlling, comprising:

acquiring operation instruction;

judging whether the first electronic device is connected to a network;

detecting second electronic devices that are located in the same network as the first electronic device and meet a preset condition, when judging that the first electronic device is connected to the network;

determining at least one second electronic device as a target electronic device, when detecting the second electronic devices that meet the preset condition;

sending control instruction to the target electronic device, wherein the control instruction is used for controlling the target electronic device to execute the control instruction.

With the application of the above technical solution, the first electronic device and the second electronic devices in the present disclosure establish communication channels for network connections through a local area network. Through the communication channels, mutual control can be implemented between the first electronic device and the second electronic devices. Compared with prior art, the present disclosure can implement mutual control between different unpaired electronic devices instead of being limited to preconfigured paired electronic devices.

### BRIEF DESCRIPTION OF THE DRAWINGS

In order to illustrate technical solutions in the present disclosure more clearly, hereinafter, the Figures which need to be used in describing the embodiments hereinbelow are introduced briefly. Obviously, the Figures described hereinbelow are only some embodiments of the present disclosure, a skilled person in the art may obtain other Figures according to these Figures below without creativity.

FIG. 1 is a flow chart of the remote control method based on wireless login provided by the present disclosure;

FIG. 2 is another flow chart of the remote control method based on wireless login provided by the present disclosure;

FIG. 3 is another flow chart of the remote control method based on wireless login provided by the present disclosure;

FIG. 4 is another flow chart of the remote control method based on wireless login provided by the present disclosure;

FIG. 5 is another flow chart of the remote control method based on wireless login provided by the present disclosure;

FIG. 6 is another flow chart of the remote control method based on wireless login provided by the present disclosure;

FIG. 7 is another flow chart of the remote control method based on wireless login provided by the present disclosure;

FIG. 8 is a flow chart of the account number log-in in the remote control method based on wireless login provided by the present disclosure;

FIG. 9 is another flow chart of the account number log-in in the remote control method based on wireless login provided by the present disclosure;

FIG. 10 is another flow chart of the account number log-in in the remote control method based on wireless login provided by the present disclosure;

FIG. 11 is another flow chart of the account number log-in in the remote control method based on wireless login provided by the present disclosure;

FIG. 12 is another flow chart of the account number log-in in the remote control method based on wireless login provided by the present disclosure;

FIG. 13 is a schematic diagram of the remote control device based on wireless login provided by the present disclosure;

FIG. 14 is a schematic diagram of the detection module in the remote control device based on wireless login provided by the present disclosure;

FIG. 15 is another schematic diagram of the remote control device based on wireless login provided by the present disclosure;

FIG. 16 is another schematic diagram of the remote control device based on wireless login provided by the present disclosure;

FIG. 17 is a schematic diagram of the second acquisition module in the remote control device based on wireless login provided by the present disclosure;

FIG. 18 is another schematic diagram of the remote control device based on wireless login provided by the present disclosure;

FIG. 19 is another flow chart of the remote control device based on wireless login provided by the present disclosure;

FIG. 20 is a structure diagram of the account detection module in a remote control device based on wireless login provided by the present disclosure.

FIG. 21 is another schematic diagram of the remote control device based on wireless login provided by the present disclosure;

FIG. 22 is a flow chart of the account number log-in in the remote control method based on wireless login provided by the present disclosure;

FIG. 23 is another flow chart of the account number log-in in the remote control method based on wireless login provided by the present disclosure;

FIG. 24 is another flow chart of the account number log-in in the remote control method based on wireless login provided by the present disclosure;

FIG. 25 is another flow chart of the account number log-in in the remote control method based on wireless login provided by the present disclosure.

### DESCRIPTION OF THE EMBODIMENTS

The technical schemes in the embodiments of the present disclosure will be thoroughly and completely described below in conjunction with the accompanying figures in the embodiments of the present disclosure. It is obvious that the embodiments described herein are some of embodiments of the present disclosure rather than entire embodiments. On the basis of the embodiments of the present disclosure, other embodiments conceived by an ordinary person skilled in the art without creative labor would all fall into the scope of the present disclosure.

The remote control method based on wireless login sought for protection in the present disclosure is applied to a scene includes a first electronic device and a second electronic device, and the mutual control between the first electronic device and the second electronic device is achieved by establishing a communication channel between the two. It should be noted that the first electronic device in the present disclosure may be the mobile terminals such as tablet PAD, smart phones, feature phone, palm computer PDA, the second electronic device may be the one having output modules, including but not limited to the device having output modules such as TV, laptop computer, tablet computer, etc. For the ease that the application is more clearly described, the first electronic device is taken as the mobile phone, and the second electronic device is taken as smart television for detailed description.

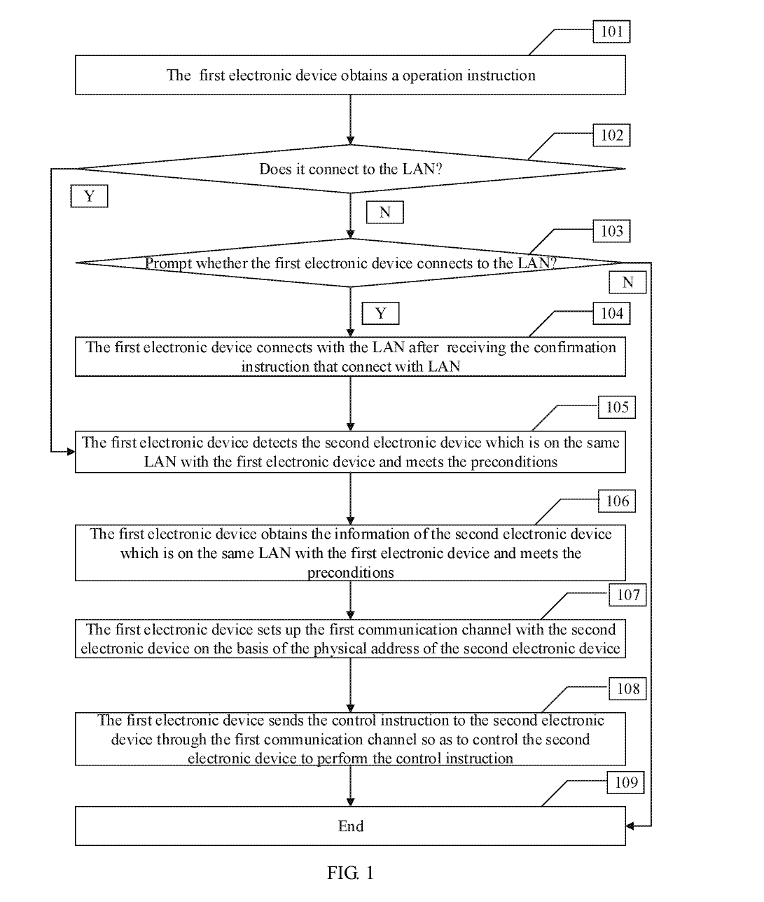

Referring to FIG. 1, it illustrates a flow chart of the remote control method based on wireless login provided in the present disclosure, includes:

In Step 101, the first electronic device obtains an operation instruction.

In the present embodiment, the operation instruction may be specially detecting the second electronic device that is located in the same local area network as the first electronic device and meets the preset condition. More specifically, obtaining operation instruction may be that the user inputs a detection instruction via the first electronic device that obtains the detection instruction, wherein when a preset user's operation is detected, the operation instruction is obtained; wherein the preset user's operation may include a preset key input operation, a shaking operation, a mouse emulation input operation or a preset gesture input operation, etc.

In Step 102, the first electronic device judges whether the first electronic device is connected to the local area network; if it is, Step 105 is performed, if not, Step 103 is performed.

In the present embodiment, whether the first electronic device is connected to the local area network refers to whether the current first electronic device is in connection status with the local area network.

In Step 103, it is prompted whether the first electronic device connects the local area network; if connected, Step 104 is performed, if not, Step 109 is performed.

In the present embodiment, when judging that the current first electronic device is not connected to the local area network, it is prompted whether the first electronic device connects the local area network. Preferably, the first electronic device automatically pops up a first prompt message to the user, and the first prompt message is for prompting the user whether selecting to connect the local area network. For example, the current first electronic device is not connected to the local area network, the first electronic device automatically pops up the first prompt message to the user, and this first prompt message may be specially a prompt box, and the prompt box includes two options of connecting the local area network and not connecting the local area network. When a user selects to connect the local area network, the first electronic device establishes network connection with the local area network; and when user selects not to connect the local area network, the first electronic device and the local area network remain open.

In Step 104, the first electronic device connects the local area network after receiving a confirmation instruction for confirming connecting the local area network.

In the present embodiment, when the user selects to connect the local area network, i.e., the user inputs a confirmation instruction that confirms connecting the local area network, and at this time, the first electronic device connects the local area network.

In Step 105, the first electronic device detects the second electronic device that is located in the same local area network as the first electronic device and meets the preset condition.

In the present embodiment, when the first electronic device detects the second electronic device that is located in the same network as the first electronic device and meets a preset condition, it will spend a large amount of network resources to search all the second electronic devices in the local area network to establish the communication channel, and the number of the second electronic device usually required by the user is only one. So, the establishment of the communication channel with all the second electronic devices searched out in the local area network not only wastes a large amount of network resources, even also results in network blockage, and network delay. On such basis, for the ease that the first electronic device efficiently detects the second electronic device that is located in the same local area network as the first electronic device and meets the preset condition, the first electronic device may detect the electronic devices that are located in same the local area network with the first electronic device, and judge whether this electronic device has a preset identification general UPNP (Universal Plug And Play) device, and obtain the first judgment result.

Wherein, the general UPNP protocol is a network protocol for aiding the first electronic device in searching the network protocol of the second electronic device. The second electronic device includes a general UPNP module, i.e., realizing being searched by the first electronic device. In practical application, each UPNP device has a physical identification for distinguishing other UPNP devices. Said identification may include attribute information representing the property of UPNP device or the device title self-defined by the user etc. In the present embodiment, for example, judging whether the electronic device has the general UPNP device with the preset identification may include judging whether the electronic device is the general UPNP device with the device name called “LeTv”, or judging whether the electronic device is the general UPNP device with the device title “LeTv” included therein.

In the present embodiment, when the first judgment result indicates that the electronic device is the UPNP device, it is determined that the second electronic device that meets the preset condition is detected.

In Step 106, the first electronic device obtains information of the second electronic device that is located in the same local area network as the first electronic device and meets the preset condition.

Wherein, the information of the second electronic device at least includes a physical address of the second electronic device. Specifically, the physical address of the second electronic device may be an IP address of the device, and MAC (Media Access Control) and the like. By the physical address of the second electronic device, the first electronic device establishes a communication channel with the second electronic device, and achieves the information interaction with the second electronic device. In the present embodiment, the first electronic device can send control instructions to a second electronic device via the communication channel.

In the present embodiment, the first electronic device may obtain all the information of the second electronic device that is located in the same local area network as the first electronic device and meets the preset condition. Preferably, after the first electronic device establishes connection with the local area network, when the first electronic device detects the second electronic device that is located in the same local area network as the first electronic device and meets the preset condition, the local area network will send all the information of the second electronic device detected by the first electronic device to the first electronic device in the form of a first device information list. The first electronic device receives the first device information list, and obtains the information of the second electronic device according to all the information of all second electronic device included this first device information list.

In Step 107, the first electronic device establishes a first channel communication with the second electronic device according to the physics address of the second electronic device.

In Step 108, the first electronic device sends control instructions to the second electronic device via the first communication channel to control the second electronic device to perform the control instructions.

In the present embodiment, the control instructions may include at least one of radio switching instruction, volume adjustment instruction, menu instruction, determination instruction or return instruction.

In Step 109, it is terminated.

In the present embodiment, after the first electronic device detects the second electronic device in the local area network that is located in the same local area network as the first electronic device and meets the preset condition, the information of the second electronic device is obtained. According to the physical address in the information of the second electronic device, the communication channel is established with the second electronic device, and thereby sending control instruction to the second electronic device via the communication channel so as to control the second electronic device to perform the control instruction.

Therefore, the first electronic device and the second electronic device in the application establish the communication channel of the network connection via the local area network, the mutual control between the first electronic device and the second electronic device can be achieved via the communication channel. Compared to prior art, the present disclosure is not confined to the pre-configured paired electronic devices, and the unpaired electronics devices can also realize mutual control therebetween.

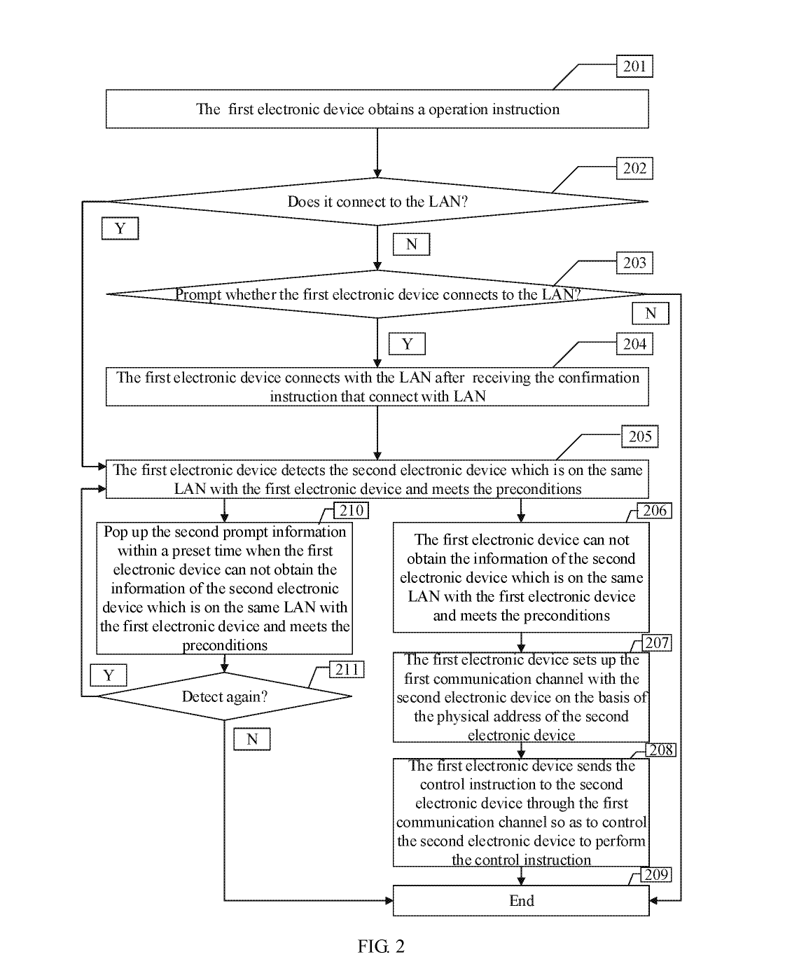

On the basis of above embodiments, the present disclosure also provides another flow chart of a remote control method based on wireless login, referring to FIG. 2, said method includes:

In Step 201, the first electronic device obtains an operation instruction;

In Step 202, the first electronic device judges whether the first electronic device is connected to local area network, if it does, Step 205 is performed; if not, Step 203 is performed;

In Step 203, it is prompted whether the first electronic device connects the local area network. If connected, Step 204 is performed; if not connected, Step 209 is performed;

In Step 204, the first electronic device connects the local area network after receiving the confirmation instruction for confirming connecting the local area network;

In Step 205, the first electronic device detects the second electronic device that is located in the same local area network as the first electronic device and meets the preset condition. If detected, Step 206 is performed, if not detected, Step 210 is performed;

In Step 206, the first electronic device obtains the information of the second electronic device that is located in the same local area network as the first electronic device and meets the preset condition;

In Step 207, the first electronic device establishes the first communication channel with the first of the second electronic device according to the physical address of the second electronic device;

In Step 208, the first electronic device send the control instructions to the second electronic device via the first communication channel so as to control the second electronic device to perform the control instructions; and

In Step 209, it is terminated.

The above steps have been describes in detail in the above embodiments, and so are not be described again here.

In Step 210, when the first electronic device cannot obtain the information of the second electronic device within the preset time that is located in the same local area network as the first electronic device and meets the preset condition, a second prompt message pops up.

Wherein, the second prompt message is used to prompt the user to select whether to redetect the second electronic device that is located in the same local area network as the first electronic device and meets the preset condition.

In Step 211, the user is prompted to select whether to redetect the second electronic device that is located in the same local area network as the first electronic device and meets the preset condition. If it does, Step 205 is performed by returning; if not, Step 209 is performed.

In the present embodiment, the preset time can be voluntarily set according to the demand of the individual subscribers or the designers. For example, the preset time is set as 5 s; i.e., when the first electronic device cannot obtain the information of the second electronic device that is located in the same local area network as the first electronic device and meets the preset condition within 5 s, the first electronic device pops up the second prompt message. Here, the second prompt message may also be a prompt box. This prompt box includes two options of re-detection and stopping detection. When the user selects re-detection, the first electronic device receives the re-detection instruction of detecting the information of the second electronic device that meets the preset conditions in the local area network, and starts re-detection in the local area network, i.e., returning to Step 205. When the first electronic device re-detects the information of the second electronic device that is located in the same local area network as the first electronic device and meets the preset conditions, and when it is detected, Step 206 is continued to perform, and the information of the second electronic device that is located in the same local area network as the first electronic device and meets the preset condition.

In addition, the present embodiment may further include when redetecting the second electronic device that is located in the same local area network as the first electronic device and meets the preset condition, and the information of the second electronic device that is located in the same local area network as the first electronic device and meets the preset condition cannot be obtain within the preset time, the first electronic device pops up the second prompt message again, and prompts the user whether to select to re-detect the second electronic device that is located in the same local area network as the first electronic device and meets the preset condition. Certainly, when the information of the second electronic device that is located in the same local area network as the first electronic device and meets the preset condition, it can also be provided as breaking detection to prompt the user to use other manners for directly or indirectly connecting the second electronic device, such as prompting the user to perform account login, and detecting the second electronic device under the same account information as the first electronic device.

In the application of the above technical solution of the present disclosure, when the first electronic device cannot obtain the information of the second electronic device that is located in the same local area network as the first electronic device and meets the preset condition, the user is prompted to select whether to re-detect the second electronic device, or whether to use other manner to re-detect.

In the present disclosure, by using the technical solution of popping up the second prompt message to prompt the user whether to re-detect the second electronic device that is located in the same local area network as the first electronic device and meets the preset condition, the user is informed of the information at the first moment that the first electronic device cannot obtain the information of the second prompt message to prompt the user whether to re-detect the second electronic device that is located in the same local area network as the first electronic device and meets the preset condition, saving the user's waiting time to obtain the second electronic device. At the same time, it is by the user to control the follow-up performing action, improving the diversification of the user.

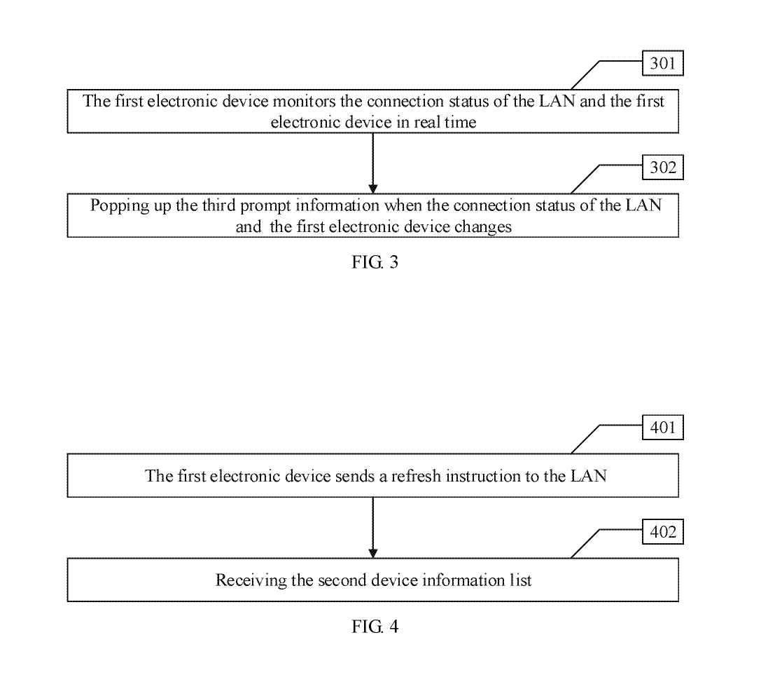

On the basis of above embodiments, referring to FIG. 3, a further flow chart of a remote control method based on wireless login is provided in the present disclosure, after the first electronic device receiving the confirmation instruction of confirming connecting the local area network to connect the local area network, the method further includes:

in Step 301, the first electronic device monitors the connection status of the local area network with the first electronic device in real time; and

in Step 302, a third prompt message pops up when the connection status of the local area network with the first electronic device changes; and wherein, the third prompt message is used to prompt the user that the connection status of the current local area network and the first electronic device connection status changes.

In the present embodiment, the instability of the network environment may lead to the disconnection, virtual connection or network blockage between the first electronic device and the local area network, etc. When the occurrence of the disconnection, virtual connection or network blockage between the first electronic device and local area network leads to failed information interaction, the first electronic device pops up a third prompt message, the third message may also specifically be a prompt box for prompting the user that the connection status between the current local area network and the first electronic device changes. At this moment, the user selects, according to the third prompt message, to re-connect the local area network, disconnect the local area network, or wait for the automatic recovery of the local area network. Therefore, in the application of the above technical schemes disclosed in the present disclosure, the user may be timely informed of the connection status of the first electronic devices and the local area network connection status, and further the user determines the follow-up performing actions of the first electronic device.

On the basis of the above embodiments, referring to FIG. 4, a further flow chart of a remote control method based on wireless login is provided in the present disclosure, after the steps obtains the information of the second electronic device that is located in the same local area network as the first electronic device and meets the preset conditions, the method further includes:

In Step 401, the first electronic device sends a refresh instruction to the local area network; wherein, the refresh instruction is used to re-detect the second electronic device that is located in the same local area network as the first electronic device and meets the preset conditions; and

In Step 402, an information list of the second device is received. Wherein, the information list of the second device includes the re-detected information of the second electronic device that is located in the same local area network as the first electronic device and meets the preset conditions.

In the present embodiment, the first electronic device sends the refresh instruction to the local area network to re-detect the information of the second electronic device that is located in the same local area network as the first electronic device and meets the preset conditions. Then the information list of the second device is received, wherein the information list of the second device includes the re-detected information of the second electronic device that is located in the same local area network as the first electronic device and meets the preset conditions.

Specifically, in the present embodiment, when the first electronic device re-detects the information list of the second device includes the re-detected information of the second electronic device that is located in the same local area network as the first electronic device and meets the preset conditions, if all the second electronic devices in the current local area network that meet the preset conditions are still all the second electronic devices previously detected by the first electronic device, the first electronic device will re-receive the information of all the second electronic devices detected in the first time. If the new second electronic device appeared in the current local area network that meets the preset conditions or one or more second electronic devices that is previously detected and meet the preset conditions disappears, then at this moment the information list of the second electronic device that is received in the first electronic device receives includes new information of the second electronic device that meets the preset conditions. With respect to the second electronic device present in the information list of the first device, but are not present in the currently moment, no second electronic devices, the information list of second device does not record the relevant information of the device.

In the application of the above technical schemes disclosed in the present disclosure, the first electronic device sends a refresh instruction to the local area network so as to real-time detect the second electronic device that is located in the same local area network as the first electronic device and meets the preset conditions, ensuring that the first electronic device quickly search the second electronic device that meets the preset conditions.

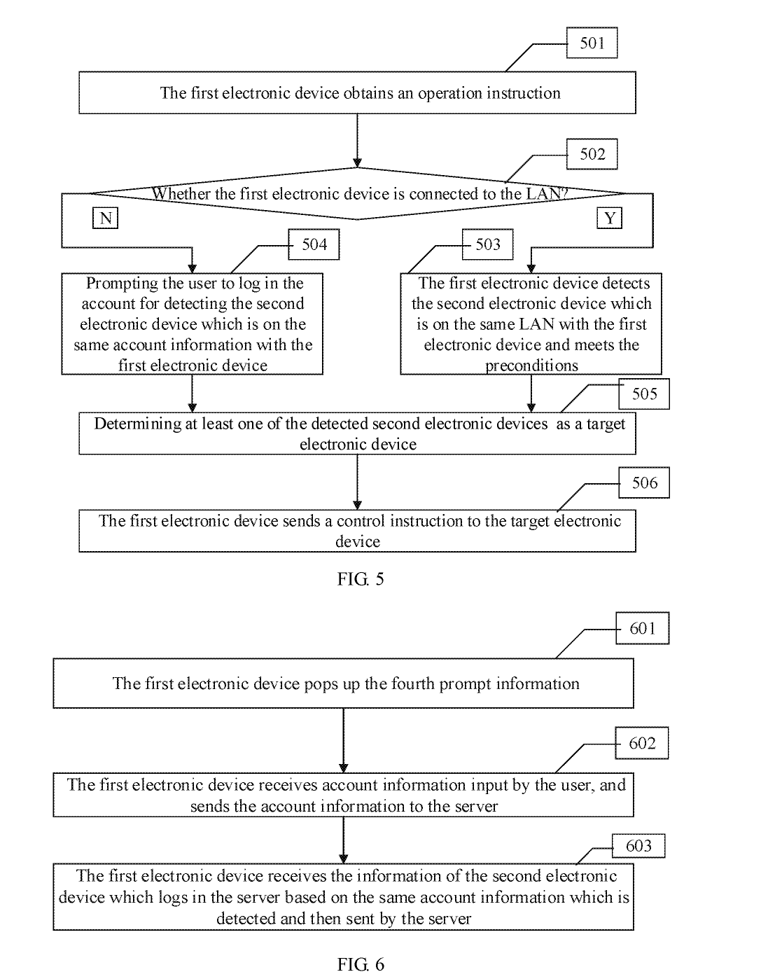

Please refer to a further flow chart of a remote control method based on wireless login in FIG. 5 provided in the application.

In Step 501, the first electronic device obtains operation instructions.

In the present embodiment, the operation instructions can be specifically detecting the second electronic device that is located in the same local area network as the first electronic device and meets the preset condition. More specifically, the obtaining operation instruction can be that the user inputs a detection instruction via the first electronic device, and the first electronic device obtains the detection instruction. Wherein, when a preset user operation is detected, the operation instruction is obtained. Wherein, the preset user operation may include a preset key input operation, a mouse emulation input operation or a preset gesture input operation, etc.

In Step 502, the first electronic device judges whether the first electronic device is connected to the local area network; if so, Step 503 is performed, and if not, Step 504 is performed.

In the present embodiment, whether the first electronic device being connected to the local area network refers to whether the first electronic device is currently connected to the LAN.

In Step 503, the first electronic device detects the second electronic device that is located in the same local area network as the first electronic device and meets the preset condition.

In the present embodiment, when the first electronic device is in connection status with the LAN, and the first electronic device detects the second electronic device that is located in the same local area network as the first electronic device and meets the preset condition, it will spend a lot of network resources to search for all the second electronic devices in the LAN to communicate, while the number of the second electronic device required by the user is usually only one. So, the communication with all the second electronic devices searched out in the LAN not only wastes a lot of network resources, or even leads to network blockage, and network delay. Based on this, in order to facilitate the first electronic device efficiently detecting the second electronic device that is located in the same local area network as the first electronic device and meets the preset condition, the first electronic device may detect the electronic device in the same LAN as the first electronic device to judge whether the electronic device is a general UPNP (Universal Plug and Play) device with the preset identification and obtain the judgment result.

Wherein, the general UPNP protocol is a network protocol used for aiding the first electronic device searching the second electronic device. The second electronic device includes a general UPNP module to realize being searched by the first electronic device. In practical application, each UPNP device has a physical identification used to distinguish other UPNP devices. The identification may compromise the attribute information representing the property of UPNP device or the user-defined device name. In the present embodiment, for example, judging whether the electronic device is a general UPNP device in the device name includes “LeTV”.

In the present embodiment, when the judgment result indicates that the electronic device is a UPNP device, it is determined that the second electronic device that meets the preset condition is detected.

In Step 504, the user is prompted for account login on the server, to detect the second electronic device under the same account information as the first electronic device.

In this embodiment, the user needs to register in advance on the server, to obtain the account information logged on the server. When the first electronic device cannot be connected to the LAN, the user logs in by entering the account information to establish connection to the server; whilst the server is connected to the second electronic device. Thus, the indirect communication can be realized between the first electronic device and a second electronic device via the server.

In Step 505, from the detected second electronic devices that meets preset conditions in the same LAN, or the detected second electronic devices under the same account information as that of the first electronic device, the first electronic device determines at least one second electronic device as a target electronic apparatus.

It should be noted that, in the present embodiment, when the number of the detected second electronic devices that meet preset conditions in the same local area network is 1, or, the number of the detected second electronic devices under the same account information as that of the first electronic devices is 1, it may be provided that the unique detected second electronic device the first electronic device can be set by default to determine as the target electronic device.

In Step 506, the first electronic device sends control instructions to the target electronic device. Wherein, the control instructions are used to control the target electronic device to perform the control instructions.

In this embodiment, the control instructions may include radio switching instruction, volume adjustment instruction, menu instruction, determination instruction or return instruction.

In practical application, for the wireless wifi network connection, no matter from the view of network transmission speed of the data transmission, or the charges of flow by the user, the wireless wifi network connections are better than ordinary 2G, 3G network connections. Accordingly, in the present embodiment, the wireless connection of the first electronic device connecting to a wireless LAN is preset with greater priority than the user account logging priority.

Specifically, when the user controls the second electronic device via the first electronic device, via the detected operation instruction input by the user, it is judged firstly whether the first electronic device is currently connected to the LAN. If it is connected to the LAN, the second electronic device that is located in the same local area network as the first electronic device and meets the preset condition is detected directly. If the first electronic device is not currently connected to the LAN, the user is prompted of account login to detect and obtain the second electronic device under the same account information as that of the first electronic device. Furthermore, in the detected second electronic device that is located in the same local area network as the first electronic device and meets the preset condition, or the detected second electronic devices under the same account information as that of the first electronic device, at least one second electronic device is determined as the target electronic device. The first electronic device sends the control instructions to the target electronic device to control the target electronic device to perform the control instructions.

In the present disclosure, by using the technical solution of the present disclosure, the second electronic device that is located in the same local area network as the first electronic device and meets the preset condition is directly detected in the LAN, when the first electronic device is not connected to the LAN, detecting the second electronic device under the same account information as the first electronic device via the account login, and further determining at least one second electronic device from all the detected second electronic devices as the target electronic device to send control instructions to target electronic device. Accordingly, in the present disclosure, the mutual control of the first electronic device and the second electronic device can be achieved by the direct network connection in the LAN, or the indirect connection of account login between the first electronic device and the second electronic device. Compared to the prior art, the present disclosure is not limited to the pre-configured paired electronic devices, the unpaired different electronic devices can also achieve mutual control.

On the basis of the above embodiments, referring to FIG. 6, in the remote control method based on wireless login provided in the present disclosure, the user is prompted of account login to obtain the second electronic device under the same account information as the first electronic device, the method includes:

In Step 601, the first electronic device pops up a fourth prompt message, wherein the fourth prompt message is used for prompting the user to select whether to perform account login.

In this embodiment, the fourth prompt message may specifically be a prompt box, includes at least the account login option. When the user determines logging into the account, the first electronic device detects the confirmation instruction of account login input by the user, and the account login process is activated.

In Step 602, the first electronic device receives the account information input by the user, and sends account information to the server.

Wherein, the account information may be but are not limited to the user name and password self-defined by the user.

In this embodiment, the user inputs the account information in the first electronic device, and the first electronic device sends the account information to the server for authentication. When the server authentication is passed, it indicates that the first electronic device can be logged on to the server, and the login of the first electronic device is realized. When the server authentication fails, the server sends an authentication failed message to the first electronic device to prompt the user to re-input account information.

It should be noted that, in this embodiment, the first electronic device needs to be registered on the server in advance to obtain account information. Correspondingly, the second electronic device also needs to be registered on the server to obtain account information as well. Under the same account information, when the first electronic device and the second device log on the server at the same time, the first electronic device can obtain the information of the second electronic device. Similarly, the second electronic devices can also obtain the information of the first electronic device. The information exchange between the first electronic device and the second electronic device is completed via the server transit.

In Step 603, the first electronic device receives the information of the second electronic device that is sent by the server and logs on the server based on the same account information detected by the server.

In this embodiment, the server will send the information of all second electronic devices that are currently logging on to the server and based on the same account as the first electronic device to the first electronic device. The first electronic device receives the information of all the second electronic devices.

It should be noted that, when a user uses account login, the information interaction between the first electronic device and the second electronic device is completed via the server transmit, in this embodiment, sending control instructions to the target electronic device specifically refers to that: the first electronic device sends a control instruction to the server, and then the server forwards the control instruction to the target electronic device to control the target electronic device to execute the control instruction.

In the application of the above technical schemes of the present disclosure, the present disclosure supports that when the first electronic device can't connect to the LAN, the connection with the server can be realized via account login, and further forwarding the instructions by the means of the server to realize the communication connection between the first electronic device and the second electronic device, and ultimately achieving the mutual control between the first electronic device and the second electronic device.

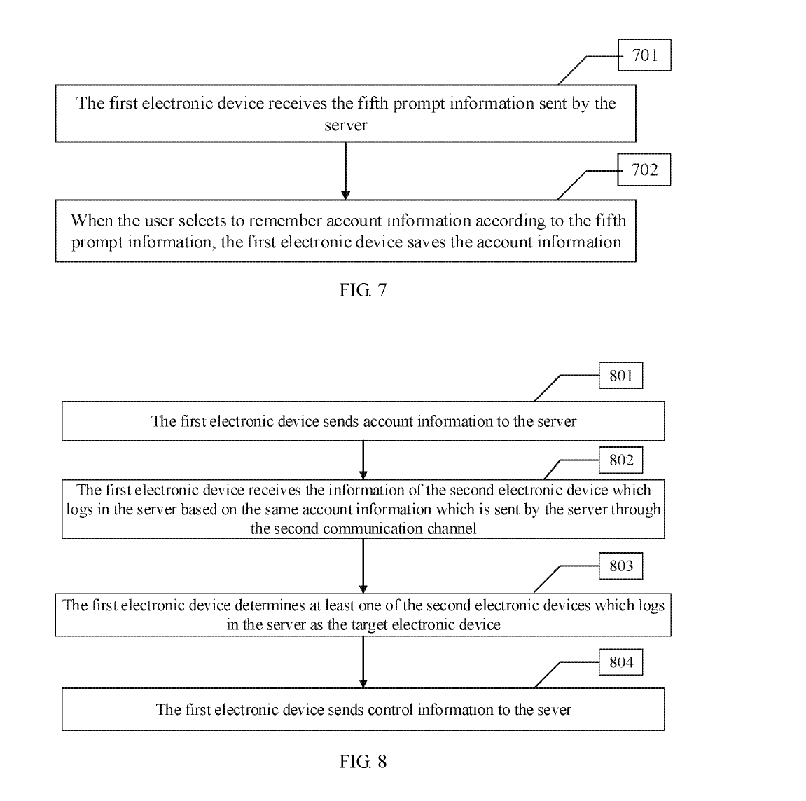

On the basis of the above embodiments, referring to FIG. 7, in the remote control method based on wireless login provided in the present disclosure, when the first electronic device logs on to the server via the account information, and after the first electronic device sends the control instruction to the server, the method further includes:

In Step 701, the first electronic device receives a fifth prompt message sent by the server, wherein the fifth message is used to prompt the user to select whether to remember the account information.

In this embodiment, the fifth prompt message can also be a prompt box, which is used to prompt the user to select whether to remember the account information. Specifically, after the user selects to remember the account information, the first electronic device automatically saves the account information.

In Step 702, when the user selects to remember the account information according to the fifth prompt message, the first electronic device saves the account information.

Therefore, in this embodiment, when the user selects the account login again, the first electronic device directly sends the saved account information to the server to achieve the account login.

In the application of the above technical schemes of the present disclosure, the preservation of account information can be realized in the present disclosure and furthermore, when the user logs in again, the logging can be realized without the need to re-enter the account information, which improves the connection speed between the first electronic device and the server.

On the basis of the above embodiments, referring to FIG. 8, it indicates that in the remote control method based on wireless login, the user performs login to detect the second electronic device under the same account information as the first electronic device, the method includes:

In Step 801, the first electronic device sends the account information to the server, wherein, the account information includes the physical address of the first electronic device.

In this embodiment, first it requires the user to log on to the server via the first electronic device. In particular, the user inputs account information in the first electronic device, and the first electronic device sends the account information to the server for authentication. When the server authentication is passed, it indicates that the first electronic device can be logged on to the server, and the first electronic device login can be achieved. Here, the account information can be but not limited to the user name and password self-defined by the user.

When the first electronic device logs on to the server, the server obtains the physical address of the first electronic device in the account information, and the second communication channel between the first electronic device and the server is established based on the physical address of the first electronic device.

Wherein, the physical address of the first electronic device can be the IP address, MAC (Media Access Control) of the device, etc. The server establishes the second communication channel with the first electronic device via the physical address of the first electronic device, realizing the information interaction with the first electronic device. In this embodiment, the first electronic device can send control instructions and data information to the server via the second communication channel.

In Step 802, receive the information of the second electronic device that logs in the server based on the same account information through the second communication channel. Wherein, the information of the second electronic device includes at least physical address of the second electronic device.

In this embodiment, the server will send the information of the second electronic device that is based on the same account information with the first electronic device, and currently logs in the server to the first electronic device through the second communication channel. Wherein, the information of the second electronic device includes at least physical address of the second electronic device. Herein, the physical address of the second electronic device on which the server bases may be used to set up a communication channel between the second electronic device and the server to perform information exchange between the second electronic device and the server.

Preferably, the server can send all of the information of the second electronic device that currently logs in the server based on the same account information to the first electronic device in the form of a list. The first electronic device receives a device list sent by the server and obtains information of the second electronic device from the device list.

Step 803, the first electronic device determines at least one of the second electronic devices that is logging in the server as a target electronic device according to the information of the second electronic device.

It should be noted that it can be set that the first electronic device can automatically default the second electronic device as a target electronic device when only one second electronic device is logging in the server based on the same account information.

Step 804, when sending control information to the server, the control information includes at least the information of the target electronic device and the first control instruction.

Wherein, the information of the target electronic device includes the physical address of target electronic device on which the server bases is used to set up a third communication channel between the target electronic device and the server after the server receives the physical address of the target electronic device, and the server sends the first control instruction sent by the first electronic device to the target electronic device through the third communication channel. The first control instruction is used to perform the first control instruction after the target electronic device receives the first control instruction.

Wherein, the first control instruction may include at least one of radio switching instruction, volume adjustment instruction, menu instruction, determination instruction and return instruction.

Specifically, in the embodiment of the present disclosure, after receiving the control information that the first electronic device sent to the server, the server obtains information of the target electronic device from the control information, and then obtain the physical address of the target electronic device, and then sets up a third communication channel between the target electronic device and the server according to the physical address of the target electronic device. Then the server sends the first control instruction sent by the first electronic device to the target electronic device by using the third communication channel.

Applying the above-described technical proposal, the first electronic device of the present disclosure sends the server account information that includes the physical address of the first electronic device. Based on the physical address of the first electronic device, the server sets up the second communication channel with the first electronic device. Meanwhile, the first electronic device receives the information of the second electronic device that currently logs in the server based on the same account information by using the second communication channel, and determines at least one of the second electronic devices as the target electronic device. At this time, the first electronic device sends the server control information that includes at least the physical address of the target electronic device and the first control instruction. Therefore, by using the second communication channel, the first electronic device sends the first control instruction to the server which sets up the third communication channel with the target electronic device according to the physical address of the target electronic device, and then sends the first control instruction to the target electronic device according to the third communication channel to control the target electronic device to perform the first control instruction. Accordingly, the present disclosure realizes the control function between different electronic devices by means of the server, is no longer limited between the pre-configured electronic devices in pairs, and can be realized mutual control between the electronic devices in any application scenario.

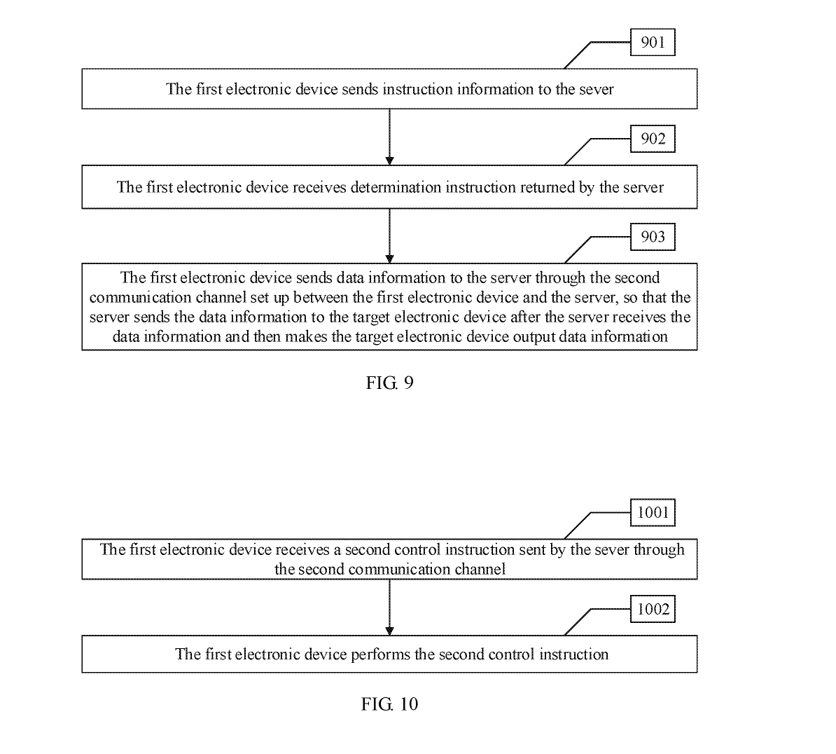

On the basis of the above embodiment, referring to FIG. 9, the present disclosure provides another flowchart of a remote control method based on wireless login, further includes:

In Step 901, the first electronic device sends the server instruction information which is used to prompt the server to control the target electronic device to turn on data reception mode.

In the embodiment, the data reception mode refers to that the target electronic device supports to receive data information and to output data information. For example, the first electronic device sends video data information to the server, and then the server sends the video data information to the target electronic device, and then the target electronic device receives the video data information and outputs the video data information to perform video play.

In Step 902, the first electronic device receives determination instruction returned by the server. The determination instruction is used to inform the first electronic device that the target electronic device has turned on data reception mode.

In Step 903, by using the second communication channel set up between the first electronic device and the server, the first electronic device sends data information to the server so that the server sends the data information to the target electronic device after the server receives the data information and then makes the target electronic device output the data information.

In the embodiment, after receiving the determination instruction returned by the server, the first electronic device determines that the target electronic device has currently turned on data reception mode, and then sends data information to the target electronic device to ensure that the target electronic device can receive the data information and output the data information, and to ensure accuracy and efficiency of transmission of the data information.

Wherein, the data information may include at least one of image information, video information and audio information, may be data information stored locally by the first electronic device, and also may be data information obtained from the Internet by the first electronic device, and may also be link information corresponding to the data information that the first electronic device obtained from the Internet. The target electronic device can obtain data information on the basis of the link information after receiving the link information corresponding to the data information.

Applying the above technical proposal, the present disclosure also allows the users to send data information to the second electronic device by means of the first electronic device, to achieve the data information of the first electronic device, such as video information, audio information, image information and the like to continue output on the second electronic device, which extends control functions between the electronic devices.

On the basis of the above embodiment, referring to FIG. 10, the present disclosure provides another flowchart of a remote control method based on wireless login, further includes:

In Step 1001, the first electronic device receives a second control instruction sent by the server through the second communication channel. The second control instruction is sent to the server via the second electronic device.

In Step 1002, the first electronic device performs the second control instruction.

Wherein, the second control instruction may include at least one of radio switching instruction, volume adjustment instruction, menu instruction, determination instruction and return instruction.

Applying the above technical proposal, the first electronic device in the present disclosure may also receive and perform the second control instruction that is sent by the second electronic device and transmitted via the server. Accordingly, the technical proposal that the present disclosure protects supports mutual control function between the different electronic devices.

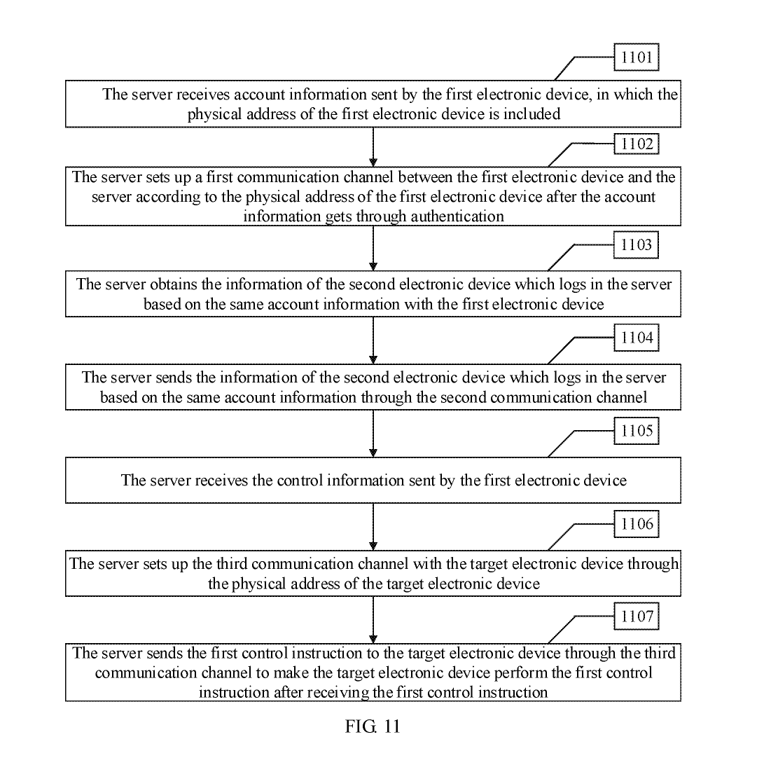

On the basis of the server, referring to FIG. 11, the present disclosure provides another flowchart of a remote control method based on wireless login, further includes:

Step 1101, the server receives account information sent by the first electronic device that includes the physical address of the first electronic device.

Wherein, the server receives the account information sent by the user through the first electronic device. The account information may be a user-defined user name and password, though not limited thereto.

In Step 1102, the server sets up a first communication channel between the first electronic device and the server based on the physical address of the first electronic device after the account information gets through authentication.

In the embodiment, after receiving the account information sent by the first electronic device, the server needs to authenticate the account information. The first electronic device can log in the server after the account information gets through authentication. After the first electronic device logs in the server, the server sets up the first communication channel with the first electronic device based on the physical address of the first electronic device in the account information, and thus achieve information interact with the first electronic device. Wherein, the physical address of the first electronic device may be such as IP address of the device, MAC (Media Access Control) and so on.

In Step 1103, the server obtains the information of the second electronic device that logs in the server based on the same account information with the first electronic device. Wherein, the information of the second electronic device includes at least the physical address of the second electronic device.

In the embodiment, the account information of the second electronic device is same with the account information of the first electronic device. It demonstrates that the first electronic device can log in the server after the server gets through authentication, and then achieves the first electronic device to log in. Meanwhile, according to the account information of the first electronic device, the server obtains all the information of the second electronic device that logs in the server based on the same account information. Further, the information of the second electronic device includes at least the physical address of the second electronic device.

In Step 1104, the server sends the information of the second electronic device that logs in the server based on the same account information through the first communication channel.

Preferably, in the present embodiment, the server may send the list of all of the information of the second electronic device that logs in the server based on the same account information with the first electronic device in the form of a list to the first electronic device.

In Step 1105, the server receives control information sent by the first electronic device. Wherein, the control information includes at least the information of the target electronic device and the first control instruction.

Wherein, the target electronic device determines at least one of the second electronic devices that logs in the server based on the same account information as the target electronic device via the first electronic device. The information of the target electronic device includes the physical address of the target electronic device.

In the embodiment, after the user determines the target electronic device through the first electronic device, the first electronic device sends the information of determined target electronic device to the server, which the server determines the target electronic device on the basis of the physical address of the target electronic device. The first control instruction is used to perform itself after the target electronic device receives the first control instruction. The first control instruction may include at least one of radio switching instruction, volume adjustment instruction, menu instruction, determination instruction and return instruction.

In Step 1106, the server sets up the second communication channel with the target electronic device on the basis of the physical address of the target electronic device.

In the embodiment, the server sets up the second communication channel with the target electronic device after receiving the physical address of the target electronic device, and achieve information interact with the second electronic device through the second communication channel.

In Step 1107, the server sends the first control instruction to the target electronic device through the second communication channel to make the target electronic device perform the first control instruction after the target electronic device receives the first control instruction.

Specially, in the embodiment, the server sets up the second communication channel with the target electronic device on the basis of the physical address of the target electronic device, and sends the first control instruction to the target electronic device through the second communication channel to control the target electronic device to perform the first control instruction.

Applying the above technical proposal, the server sets up the first communication channel with the first electronic device through the physical address of the first electronic device, and sets up the second communication channel with the second electronic device through the physical address of the second electronic device, and then interacts with the first electronic device through the first communication channel, interacts with the second electronic device through the second communication channel respectively, namely to achieve the establishment of association of the first electronic device associated and the second electronic device, so as to realize mutual control between different electronic devices.

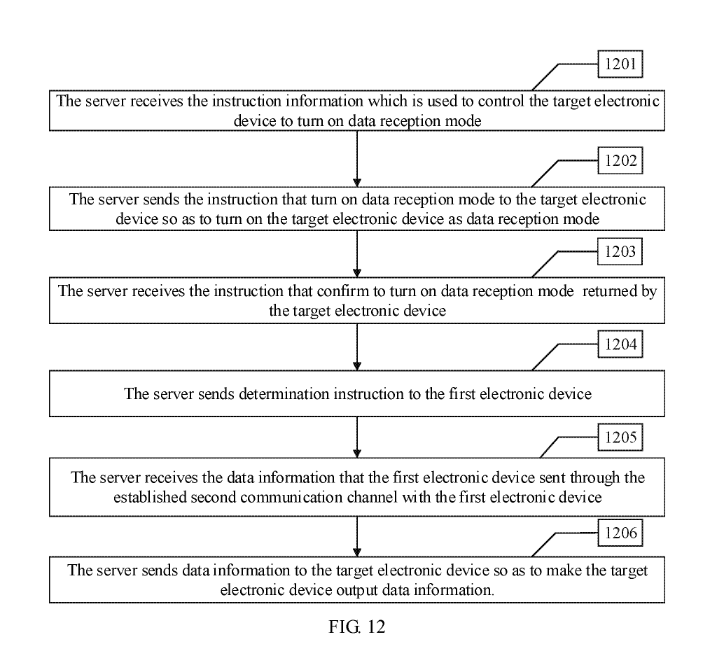

Referring to FIG. 12, the present disclosure provides another flowchart of a remote control method based on wireless log in, on the basis of the above-described embodiments, further includes:

In Step 1201, the server receives the instruction information that is used to control the target electronic device to turn on data reception mode.

Wherein, the data reception mode refers to that the target electronic device supports to receive data information, and to output data information. For example, the first electronic device sends video data information to the server. The server sends video data information to the target electronic device. The target electronic device receives the above video data information, and then outputs the video data information, and then achieves the playback of video.

In the embodiment, the server performs Step 1202 after receiving the instruction information sent by the first electronic device, and sends the instruction that turn on data reception mode to the target electronic so as to turn on the target electronic as data reception mode.

In Step 1202, the server sends the instruction that turn on data reception mode to the target electronic device so as to turn on the target electronic as data reception mode.

In Step 1203, the server receives the instruction that confirm to turn on data reception mode that is returned by the target electronic device.

The target electronic device turns on data reception mode after receiving the instruction that turn on data reception mode sent by the server, and then returns the instruction that confirm to turn on data reception mode to the server, so as to inform the server that the target electronic device has turned on as data reception mode.

In Step 1204, the server sends determination instruction to the first electronic device. Wherein, the determination instruction is be used to inform the first electronic device that the target electronic device has turned on data reception mode.

In Step 1205, the server receives the data information sent by the first electronic device through the first communication channel which is set up between the server and the first electronic device

Wherein, the data information may include at least one of video information, audio information and image information, and may also be the data information stored locally by the first electronic, device data and may also be the data information obtained by the first electronic device from the Internet, and may also be link information corresponding to the data information obtained by the first electronic device from the Internet. The target electronic can obtain data information on the basis of the link information after receiving the link information corresponding to the data information.

In Step 1206, the server sends the data information to the target electronic device so as to make the target electronic device output data information.

Applying the above technical proposal, the present disclosure supports that the user sends data information to the second electronic device through the first electronic device, to achieve that the data information of the first electronic device such as audio information, video information and image information and the like to continue to output on the second electronic device, which extends the control function between electronic devices.

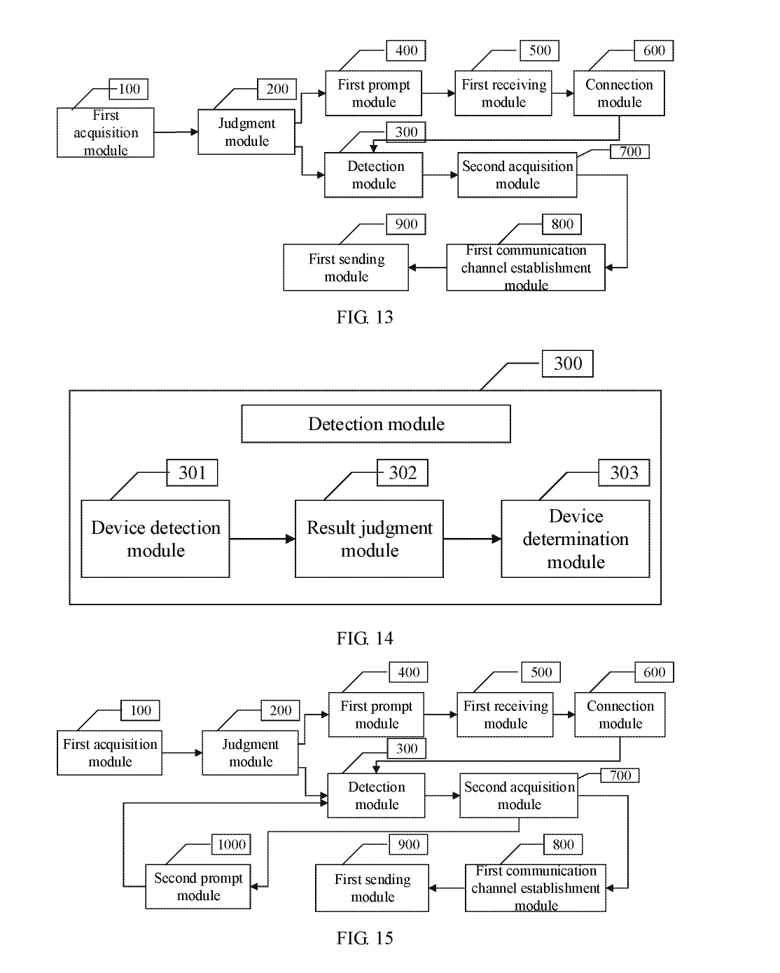

On the basis of the above remote control method based on wireless login that the present disclosure protects, the present disclosure also provides a remote control device based on wireless login, which is applied to the first electronic device, referring to FIG. 13, includes: a first acquisition module 100, a judgment module 200, a detection module 300, a first prompt module 400, a first receiving module 500, a connection module 600, a second acquisition module 700, a first communication channel establishment module 800 and a first sending module 900. Wherein,

The first acquisition module 100, is set to obtain operation instruction.

The judgment module 200, is set to judge whether the first electronic device is connected to a local area network (LAN) after the first acquisition module 100 obtains the operation instruction.

The detection module 300, is set to detect the second electronic device that is on the same local area network with the first electronic device and meets the preconditions when the first electronic device connects the LAN.

The first prompt module 400, is set to prompt whether the first electronic device connects with the LAN when the first electronic device does not connect with the LAN.

Wherein, the first prompt module 400 is specially set to pop up the first prompt information that is used to prompt the user to select whether to connect the LAN.

The first receiving module 500, is set to receive the confirmation instruction that confirm to connect the LAN.

The connection module 600, is set to connect the LAN after the first receiving module 500 receives the confirmation instruction that confirm to connect the LAN.

Wherein, the detection module 300 is specially set to detect the second electronic device that is on the same LAN with the first electronic device and meets the preconditions after the connection module 600 connects the LAN.

The second acquisition module 700, is set to obtain the information of the second electronic device that is on the same LAN with the first electronic device and meets the preconditions. Wherein, the information of the second electronic device includes at least the physical address of the second electronic device.

The first communication channel establishment module 800, is set to establish the first communication channel with the second electronic device on the basis of the physical address of the second electronic device.

The first sending module 900 is set to send the control instruction to the second electronic device through the first communication channel so as to control the second electronic device to perform the control instruction.

Applying the above-described technical proposal of the present disclosure, the first electronic device and second electronic device in the present disclosure set up the communication channel of network connection through the LAN, through which it can achieve the mutual control between the first electronic device and the second electronic device. Compared to the existing technical, the present disclosure is not limited between the coupled electronic devices.

Referring to FIG. 14, the present disclosure provides a structure diagram of a detection module in the remote control device based on wireless login, includes: a device detection module 301, a result judgment module 302 and a device determination module 303. Wherein,

The device detection module 301, is set to detect an electronic device that is on the same LAN with the first electronic device.

The result judgment module 302, is set to judge whether the electronic device detected by the device detection module 301 is an UPNP (universal plug and play) device with the pre-set logo, and then obtain first judgment result.

The device determination module 303, is set to determine the detected second electronic device that conforms with the precondition when the first judgment result shows that the electronic device is UPNP.

On the basis of the above-described embodiments, the present disclosure provides a structure diagram of a remote control device that based on wireless login, referring to FIG. 15, also includes:

A second prompt module 1000, is set to pop up the second prompt information within a preset time when the second acquisition module 700 cannot get access to the information of the second electronic device that is on the same LAN with the first electronic device and meets the preconditions. The second prompt information is used to inform the user whether to detect afresh the second electronic device that is on the same LAN with the first electronic device and meets the preconditions.

When selecting to detect afresh the second electronic device that is on the same LAN with the first electronic device and meets the preconditions according to the second prompt information, the user determines that the first electronic device detects afresh the second electronic device that is on the same LAN with the first electronic device and meets the preconditions.

Applying the above-described technical proposal of the present disclosure, the present disclosure prompts the user whether to detect afresh the second electronic device that is on the same LAN with the first electronic device and meets the preconditions by using the technical means that the second prompt information popped up by the second prompt module 1000, and informs the user in the first time that the first electronic device cannot get access to the information of the second electronic device that is on the same LAN with the first electronic device and meets the preconditions, which saves the user time for waiting to obtain a second electronic device. At the same time, it improves the diversification of user operation that the user controls to perform a follow-up action of the first electronic device.

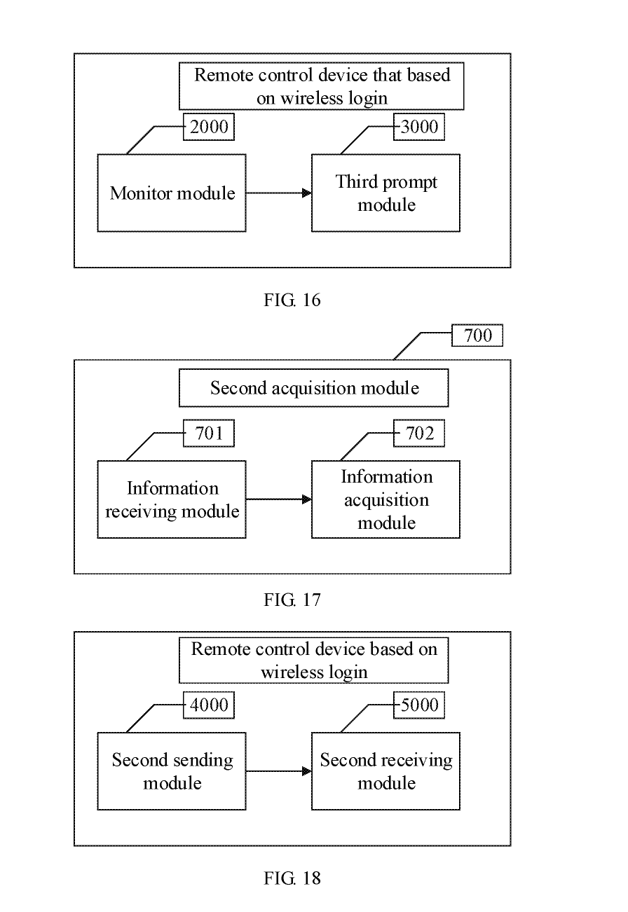

On the basis of the above-described embodiments, the present disclosure provides another structure diagram of a remote control device based on wireless login, referring to FIG. 16, also includes: a monitor module 2000 and a third prompt module 3000. Wherein,

The monitor module 2000, is set to monitor the connection status of the LAN connecting with the first electronic device in real time.

The third prompt module 3000, is set to pop up a third prompt information when the connection status of the LAN connecting with the first electronic device monitored by the monitor module 2000 changes.

Applying the above-described technical proposal of the present disclosure, the present disclosure achieves to monitor the connection status of the LAN connecting with the first electronic device in real time.

Referring to FIG. 17, the present disclosure provides a structure diagram of the second acquisition module in a remote control device based on wireless login, includes: an information receiving module 701 and an information acquisition module 702. Wherein,

The information receiving module 701, is set to receive an information list of the first device that includes the information of the second electronic device that is on the same LAN with the first electronic device and meets the preconditions.

The information acquisition module 702, is set to obtain the information of the second electronic device that is on the same LAN with the first electronic device and meets the preconditions according to the information list of the first device.

On the basis of the above-described embodiments, the present disclosure provides another structure diagram of a remote control device based on wireless login, referring to FIG. 18, also includes: a second sending module 4000 and a second receiving module 5000. Wherein,

The second sending module 4000, is set to send a refresh instruction to the LAN. The refresh instruction is used to detect afresh the second electronic device that is on the same LAN with the first electronic device and meets the preconditions.

The second receiving module 5000, is set to receive an information list of a second device. The information list of the second device includes the information of the second electronic device that is detected afresh and is on the same LAN with the first electronic device and meets the preconditions.

Applying the above-described technical proposal disclosed by the present disclosure, the first electronic device in the present disclosure may detect in real time the second electronic device that exists in the LAN and meets the preconditions, which makes sure that the first electronic device can quickly find the second electronic device that meets the preconditions in time.

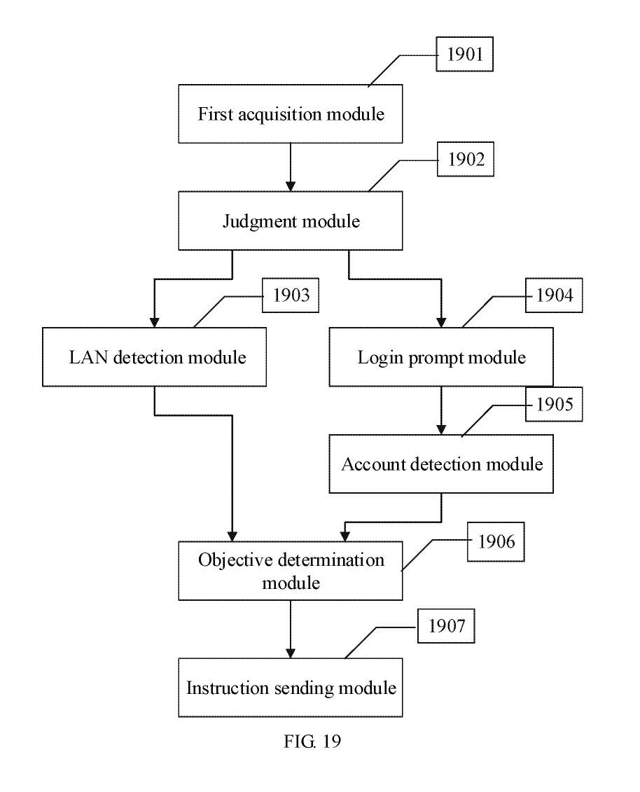

On the basis of the above-described embodiments, the present disclosure also provides a remote control device based on wireless login, referring to FIG. 19, the present disclosure includes: a first acquisition module 1901, a judgment module 1902, a LAN detection module 1903, a login prompt module 1904, an account detection module 1905, an objective determination module 1906 and an instruction sending module 1907. Wherein,

The first acquisition module 1901, is set to obtain operation instruction.

The judgment module 1902, is set to judge whether the first electronic device connects with the LAN after the first acquisition module 1901 obtains a operation instruction.

The LAN detection module 1903, is set to detect the second electronic device that is on the same LAN with the first electronic device and meets the preconditions when the judgment module 1902 judges that the first electronic device connects to the LAN.

The login prompt module 1904, is set to prompt the user to log in the server with account when the judgment module 1902 judges that the first electronic device does not connect to the LAN.

The account detection module 1905, is set to detect the second electronic device that is on the same account information with the first electronic device after the user performs to log in the server with the account.

The objective determination module 1906, is set to determine at least one of the second electronic devices as the target electronic device among the second electronic devices that is on the same LAN with the first electronic device and meets the preconditions detected by the LAN detection module 1903 or that is on the same account information with the first electronic device detected by the LAN detection module 1903.

The instruction transmission module 1907, is set to send the target electronic device a control instruction that is used to control the target electronic device to perform the control instruction.

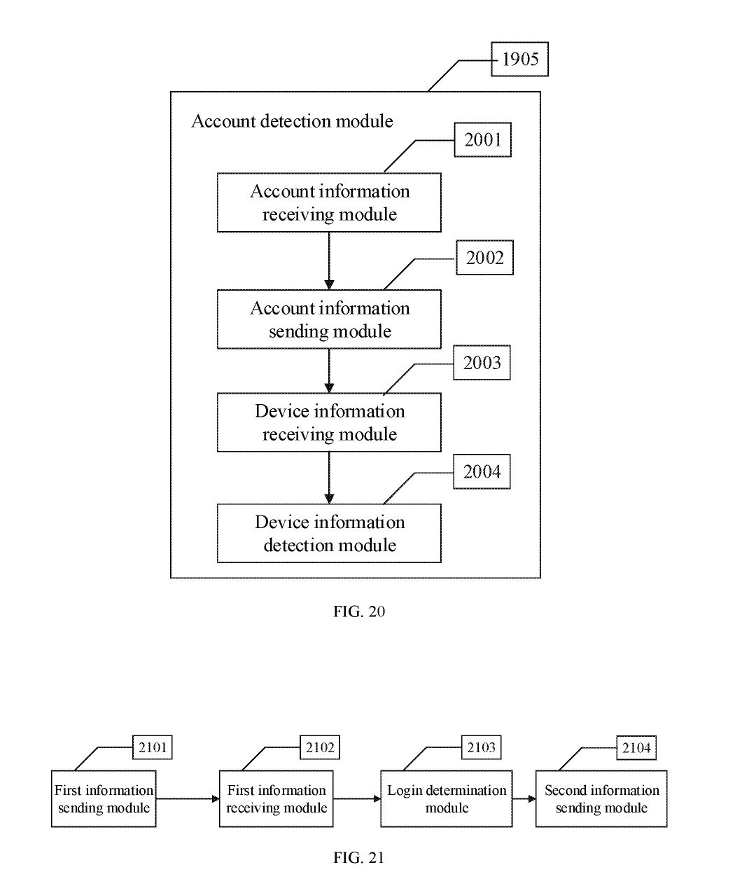

Referring to FIG. 20, a structure diagram of the account detection module 1905 in a remote control device based on wireless login provided by the present disclosure, includes: an account information receiving module 2001, an account information sending module 2002, a device information receiving module 2003 and a device information detection module 2004. Wherein,

The account information receiving module 2001, is set to receive the account information input by the user.

The account information transmission module 2002, is set to send the account information to the server.

The device information receiving module 2003, is set to receive the information of the second electronic device that logs in the server based on the same account information that is detected and then sent by the server.

The device information detection module 2004, is used to detect the second electronic device that is on the same account information with the first electronic device according to the information of the second electronic device.

Wherein, in the present embodiment, the instruction sending module 1907 is specially set to send the control instruction to the server, so that the server sends the control instruction to the target electronic device, and thus controls the target electronic device to perform the control instruction.

On the basis of the above-described embodiments, the present disclosure also provides a remote control device based on wireless login, referring to FIG. 21, the login prompt module includes: a first information sending module 2101, a first information receiving module 2102, a login determination module 2103 and a second information sending module 2104. Wherein,

The first information sending module 2101, is set to send the server the account information that includes the physical address of the first electronic device.

The physical address of the first electronic device is set to set up the first communication channel between the first electronic device and the server according to the physical address of the first electronic device after the server receives the physical address of the first electronic device.

The first information receiving module 2102, is set to receive the information of the second electronic device that logs in the server based on the same account information sent by the server through the first communication channel. Wherein, the information of the second electronic device includes at least the physical address of the second electronic device.

The login determination module 2103, is set to determine at least one of the second electronic devices logging in the server as the target electronic device.

The second information sending module 2104, is set to send the server the control information that includes at least the information of the target electronic device and the first control instruction.

Wherein, the information of the target electronic device includes the physical address of the target electronic device that is used to set up a second communication channel between the target electronic device and the server according to the physical address of the target electronic device after the server receives the physical address of the target electronic device. The server sends the first control instruction sent by the first electronic device to the target electronic device through the second communication channel. The first control instruction is used to perform itself after the target electronic device receives the first control instruction.

With regard to specific description of the device, it can refer to description of the above method the inventors herein no longer describes in detail.

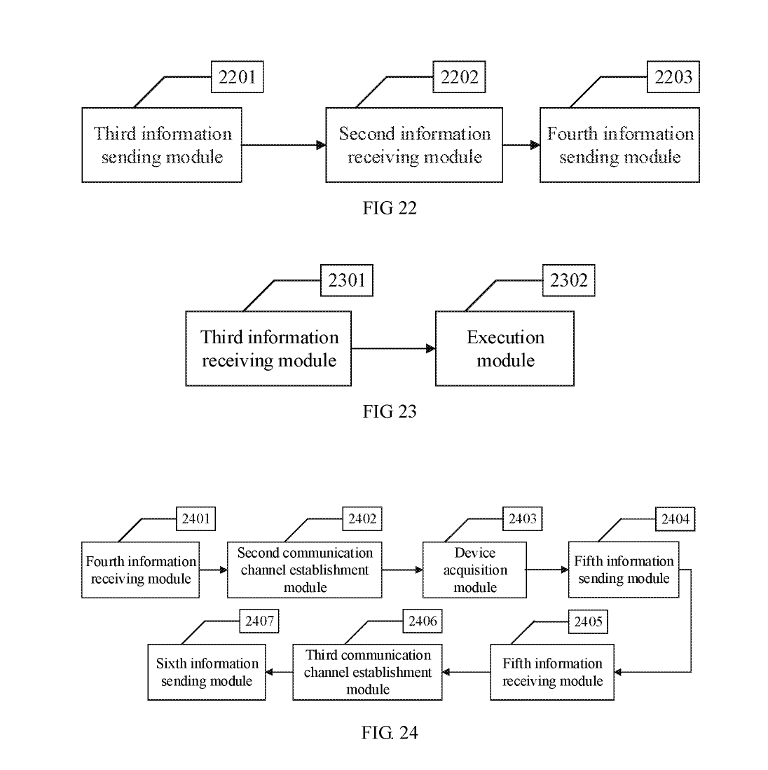

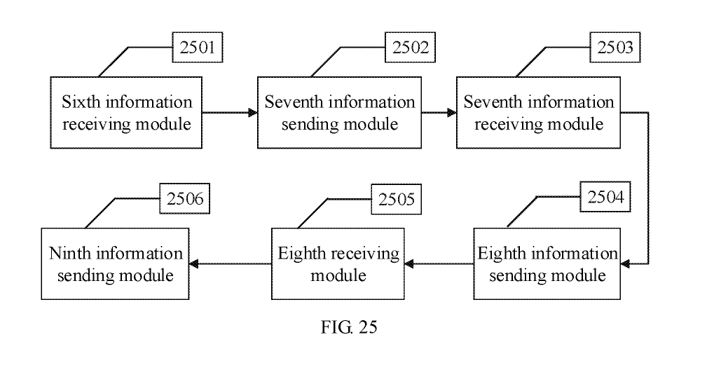

On the basis of the above embodiments, referring to FIG. 22, the present disclosure provides another structure diagram of a remote control device based on wireless login, includes: a third information sending module 2201, a second information receiving module 2202 and a fourth information sending module 2203. Wherein,

The third information sending module 2201, is set to send the server instruction information which is used to prompt the server to control the target electronic device to turn on data reception mode.

The second information receiving module 2202, is set to receive a determination instruction returned by the server. Wherein, the determination instruction is used to inform the first electronic device that the target electronic device has turned on data reception mode.

The fourth information sending module 2203, is set to send data information to the server through the first communication channel that set up between the first electronic device and the server, to make the server send the data information to the target electronic device after the server receives the data information, so that the target electronic device outputs the data information.

With regard to specific description of the device, it can refer to description of the above method the inventors herein no longer describes in detail.

On the basis of the above embodiments, referring to FIG. 23, the present disclosure provides another structure diagram of a remote control device based on wireless login, the device includes: a third information receiving module 2301 and an execution module 2302. Wherein,

The third information receiving module 2301, is set to receive a second control instruction sent by the sever through the first communication channel, wherein, the second control instruction is sent to the server by the second electronic device.

The execution module 2302, is used to perform the second control instruction.

The second control instruction may include at least one of radio switching instruction, volume adjustment instruction, menu instruction, decision instruction and return instruction.

With regard to specific description of the device, it can refer to description of the above method the inventors herein no longer describes in detail.

In the embodiment, the first electronic device may also receive the second control instruction that is sent by the second electronic device and transmitted by the server. The technical proposal that the present disclosure protects supports control functions each other between different electronic devices.

On the basis of an above-described remote control method based on wireless login protected by the present disclosure, the present disclosure provides another structure diagram of a remote control device based on wireless login, based on the server side, referring to FIG. 24, the device includes: a fourth information receiving module 2401, a second communication channel establishment module 2402, a device acquisition module 2403, a fifth information sending module 2404, a fifth information receiving module 2505, a third communication channel establishment module 2406 and a sixth information sending module 2407. Wherein,

The fourth information receiving module 2401, is set to receive account information sent by the first electronic device, of which the physical address is included in the account information.

The second communication channel establishment module 2402, is set to establish the second communication channel between the first electronic device and the server according to the physical address of the first electronic device after the account information gets through authentication.

The device acquisition module 2403, is set to obtain the information of the second electronic device that logs in the server based on the same account information with the first electronic device. Wherein, the information of the second electronic device includes at least the physical address of the second electronic device.

The fifth information sending module 2404, is set to send the information of the second electronic device that logs in the server based on the same account information to the first electronic device through the first communication channel.

The fifth information receiving module 2505, is set to receive the control information sent by the first electronic device. Wherein, the control information includes at least the information of the target electronic device and the first control instruction. Wherein, the target electronic device determines at least one of the second electronic devices that logs in the server based on the same account information as a target electronic device. The information of the target electronic device includes the physical address of the target electronic device.

The third communication channel establishment module 2406, is set to establish a third communication channel with the target electronic device on the basis of the physical address of the target electronic device.

The sixth information sending module 2407, is set to send the first control instruction to the target electronic through the second communication channel so that the target electronic performs the first control instruction after receiving the first control instruction.

With regard to specific description of the device, it can refer to description of the above method the inventors herein no longer describes in detail.

Applying the above technical proposal, the server sets up a first communication channel between itself and the first electronic device through the physical address of the first electronic device, sets up a second communication channel between itself and the second electronic device through the physical address of the second electronic device, and then achieves to interact with the first electronic device through the first communication channel, and then achieves to interact with the second electronic device through the second communication channel, namely achieves the establishment of association between the first electronic device and the second electronic device, so as to achieve mutual control between various electronic devices.

On the basis of the above-described embodiments, referring to FIG. 15, the present disclosure provides another structure diagram of a remote control device based on wireless login, the device also includes: a sixth information receiving module 2501, a seventh information sending module 2502, a seventh information receiving module 2503, an eighth information sending module 2504, an eighth receiving module 2505 and a ninth information sending module 2506. Wherein,

The sixth information receiving module 2501, is set to receive instruction information that is used to remind that the server controls the target electronic device to turn on data reception mode.

The seventh information sending module 2502, is set to send the instruction that turn on data reception mode to the target electronic device.

The seventh information receiving module 2503, is set to receive the instruction that confirm to turn on data reception mode returned by the target electronic device.

The eighth information sending module 2504, is set to send determination instruction that is used to inform the first electronic device that the target electronic device has turned on data reception mode to the first electronic device.

The eighth receiving module 2505, is set to receive data information sent by the first electronic device through the first communication channel set up between the server and the first electronic device.

The ninth information sending module 2506, is set to send data information to the target electronic device so that the target electronic device outputs the data information.

The present disclosure supports that the user sends data information to the second electronic device through the first electronic device, so as to achieve that the data information in the first electronic device, such as video information, audio information, image information and the like continue to be output on the second electronic device, which extends control function between the electronic devices.

It should be noted that, the embodiments in the present disclosure are disclosed progressively, each embodiment mainly emphasis the differences from other embodiments, the similar part between different embodiments may be referred to each other. The various device embodiments correspond to the method embodiments, therefore the description is relatively simple, the related parts may be referred to the method embodiments.

At last, it should be noted that, in the present disclosure, the relational terms such as the first and the second are merely used to separate one entity from another entity, rather than requiring or implying practical relation or sequence of these entities and procedures. In addition, the term include or include or variant forms thereof represents the is of including but not limiting, thusly the process, method, product or apparatus which includes essentials may not only include those essentials, but also include other essentials which are not listed definitely, or may include the initial essentials of the process, method, product or apparatus. In the case that no more limitation is given, the essentials limited by the term “including” does not preclude other same or similar essentials exist in the process, method, product or apparatus.

The remote control method and device based on wireless login provided in the present disclosure are described in detail, specific case are used in the present disclosure to illustrate the principle of the application, the illustration of the embodiments is just for helping understanding the method and core concept of the application, meanwhile, for one of ordinary skill in the art, according to the thought of the application, the specific embodiments and applications may be changed, to sum up, the description should not be understood as the restriction to the application.

1. A remote control method based on wireless login applied to a first electronic device, characterized in that, the method comprises:
after obtaining an operation instruction, judging whether the first electronic device is connected to a network;
when judging that the first electronic device is connected to the network, detecting second electronic devices that are located in the same network as the first electronic device and meet a preset condition;
when detecting the second electronic devices that meet the preset condition, determining at least one second electronic device as a target electronic device; and
sending a control instruction to the target electronic device, wherein the control instruction is used for controlling the target electronic device to execute the control instruction.

2. The method according to claim 1, characterized in that,
said after obtaining an operation instruction, judging whether the first electronic device is connected to a network is: after obtaining an operation instruction, judging whether the first electronic device is connected to a local area network;
said when judging that the first electronic device is connected to the network, detecting second electronic devices that are located in the same network as the first electronic device and meet a preset condition is: when judging that the first electronic device is connected to the local area network, detecting the second electronic devices that are located in the same local area network as the first electronic device and meet a preset condition; when judging that the first electronic device is not connected to the local area network, prompting whether the first electronic device is connected to the local area network, connecting to the local area network after receiving the confirmation instruction to connect to the local area network, and detecting the second electronic devices that are located in the same local area network as the first electronic device and meet a preset condition when the first electronic device and the local area network are in a connecting state;
when detecting the second electronic devices that meet the preset condition, determining at least one second electronic device as a target electronic device is: when detecting the second electronic devices that are located in the same local area network as the first electronic device and meet a preset condition, obtaining the information of the second electronic device; wherein the information of the second electronic device at least comprises the physical address of the second electronic device;
according to the physical address of the second electronic device, building a first communication channel with the second electronic device;
said sending a control instruction to the target electronic device, wherein the control instruction is used for controlling the target electronic device to execute the control instruction is: sending a control instruction to the second electronic device through the first communication channel, so as to control the second electronic device to execute the control instruction.

3. The method according to claim 2, characterized in that, said detecting second electronic devices that are located in the same local area network as the first electronic device and meet a preset condition comprises:
detecting the electronic devices that are located in the same local area network as the first electronic device, judging whether the detected electronic device is a Universal Plug-n-Play (UPNP) device having a preset label, and obtaining a first judging result;
when the first judging result shows that the electronic device is a Universal Plug-n-Play (UPNP) device, determining that the second electronic devices which meet a preset condition are detected.

4. The method according to claim 2, characterized in that, said prompting whether the first electronic device is connected to the local area network comprises:
popping up a first prompt message for prompting the user to select whether to connect to the local area network.

5. The method according to claim 2, characterized in that, when the first electronic device is connected to the local area network, the method further comprises:
when it is unable to obtain the information of the second electronic devices that are located in the same local area network as the first electronic device and meet a preset condition within a preset time, popping up a second prompt message for prompting the user to select whether to redetect the second electronic devices that are located in the same local area network as the first electronic device and meet a preset condition;
when the user selects to redetect the second electronic devices that are located in the same local area network as the first electronic device and meet a preset condition according to the second prompt message, the first electronic device redetects the second electronic devices that are located in the same local area network as the first electronic device and meet a preset condition.

6. The method according to claim 2, characterized in that, when the first electronic device is connected to the local area network, the method further comprises:
real-time monitoring the connection state between the local area network and the first electronic device, and popping up a third prompt message when the connection state between the local area network and the first electronic device is changed; wherein the third prompt message is used for prompting the user that the connection state between the present local area network and the first electronic device is changed.

7. The method according to claim 2, characterized in that, said obtaining the information of the second electronic devices that are located in the same local area network as the first electronic device and meet a preset condition comprises:
receiving a first device information list comprises the information of the second electronic devices that are located in the same local area network as the first electronic device and meet a preset condition;
obtaining the information of the second electronic devices that are located in the same local area network as the first electronic device and meet a preset condition according to the first device information list.

8. The method according to claim 7, characterized in that, said after obtaining the information of the second electronic devices that are located in the same local area network as the first electronic device and meet a preset condition further comprises
sending an update instruction to the local area network, wherein the update instruction is used for re-detecting the second electronic devices that are located in the same local area network as the first electronic device and meet a preset condition;
receiving the second device information list comprises the re-detected information of the second electronic devices that are located in the same local area network as the first electronic device and meet a preset condition.

9. The method according to claim 1, characterized in that, after obtaining an operation instruction, judging whether the first electronic device is connected to a network is: after obtaining an operation instruction, judging whether the first electronic device is connected to a server;
said when determining that the first electronic device is connected to the network, detecting second electronic devices that are located in the same network as the first electronic device and meet a preset condition is: when the first electronic device is connected to a server, sending account information comprises the physical address of the first electronic device to the server; wherein the physical address of the first electronic device is used for building a first communication channel between the first electronic device and the server according to the physical address of the first electronic device, after the sever receives the physical address of the first electronic device;
receiving the information of the second electronic device that is sent by the server using the first communication channel and logs on to the server using the same account information; wherein, the information of the second electronic device at least comprises the physical address of the second electronic device;
said when detecting the second electronic devices that meet the preset condition, determining at least one second electronic device as a target electronic device is: determining at least one of the second electronic devices that log on to the server as the target electronic device;
said sending a control instruction to the target electronic device, wherein the control instruction is used for controlling the target electronic device to execute the control instruction is: sending a control information to the server, wherein the control information at least comprises the information of the target electronic device and the first control instruction;
wherein, the information of the target electronic device comprises the physical address of the target electronic device, wherein the physical address of the target electronic device is used for building a second communication channel between the target electronic device and the server according to the physical address of the target electronic device, after the sever receives the physical address of the target electronic device, sending the first control instruction sent by the first electronic device to the target electronic device using the second communication channel; the first control instruction is used for executing the first control instruction after the target electronic device receives the control instruction.

10. The method according to claim 9, characterized in that, the method further comprises receiving a device list sent by the server, wherein the device list comprises the information of all the second electronic devices that log on under the same account information.

11. The method according to claim 9, characterized in that, the method further comprises:
sending instruction information to the server for prompting the server to control the target electronic device to start a data reception mode;
receiving the confirmation instruction returned from the server, wherein the confirmation instruction is used for informing the first electronic device that the target electronic device starts the data reception mode;
sending data information to the server using the first communication channel built between the first electronic device and the server, so as to make the server send the data information to the target electronic device after receiving the data information, to make the target electronic device output the data information.

12. The method according to claim 9, characterized in that, the method further comprises:
receiving the second control instruction sent by the server through the first communication channel, wherein the second control instruction is sent by the second electronic device to the server;
executing the second control instruction.

13. A remote control method based on wireless login applied to a first electronic device, characterized in that, the method comprises:
after obtaining an operation instruction, judging whether the first electronic device is connected to a local area network;
when judging that the first electronic device is connected to the local area network, detecting second electronic devices that are located in the same local area network as the first electronic device and meet a preset condition;
when judging that the first electronic device is not connected to the local area network, making the first electronic device log on to a server using an account number, to detect second electronic devices that are under the account number as the first electronic device;
determining at least one second electronic device as a target electronic device among the detected second electronic devices that are located in the same local area network as the first electronic device and meet a preset condition or the detected second electronic devices that are under the same account number as the first electronic device;
sending a control instruction to the target electronic device, wherein the control instruction is used for controlling the target electronic device to execute the control instruction.

14. The method according to claim 13, characterized in that, said prompting the user to log on using account number, to detect second electronic devices that are under the account number as the first electronic device comprises:
popping up a fourth prompt message for prompting the user whether to select account number log-in;
when the user selects the account number log-in, receiving the account number inputted by the user and sending account number information to the server;
receiving the information of the second electronic device that is sent and detected by the server and logs on to the server using the same account number information;
detecting the second electronic devices that are under the same account number as the first electronic device according to the information of the second electronic message;
wherein, said sending control instruction to the target electronic device comprises:
sending control instruction to the server, to make the server send the control instruction to the target electronic device to control the target electronic device to execute the control instruction.

15. The method according to claim 14, characterized in that, when the first electronic device logs on to the server using the account number information, after the sending control instruction to the server, the method further comprises:
receiving a fifth prompt message sent by the server, wherein the fifty prompt message is used for prompting the user whether to select to remember the account number information;
when the user selects to remember the account number information according to the fifth prompt message, the first electronic device storing the account number information;
when the user selects the account number log-in again, sending the stored account number information to the server.

16. The method according to claim 13, characterized in that, the user making the account number log-in to detect the second electronic devices that are under the same account number as the first electronic device comprises:
sending account number information to the server, wherein the account number information comprises the physical address of the first electronic device; wherein the physical address of the first electronic device is used for building a second communication channel between the first electronic device and the server according to the physical address of the first electronic device, after the sever receives the physical address of the first electronic device;
receiving the information of the second electronic devices that is sent by the server using the second communication channel and logs on to the server under the same account number information; wherein the information of the second electronic device at least comprises the physical address of the second electronic device;
sending control information to the server, wherein the control information at least comprises the information of the target electronic device and the first control instruction;
wherein, the information of the target electronic device comprises the physical address of the target electronic device, wherein the physical address of the target electronic device is used for building a third communication channel between the target electronic device and the server according to the physical address of the target electronic device, after the sever receives the physical address of the target electronic device, sending the first control instruction sent by the first electronic device to the target electronic device using the third communication channel;
wherein the first electronic instruction is used for executing the first control instruction after the target electronic device receives the control instruction.

17. The method according to claim 16, characterized in that, said receiving the information of the second electronic devices that is sent by the server using the second communication channel and logs on to the server under the same account number information comprises:
receiving the device list sent by the server, wherein the device list comprises the information of all the second electronic devices that log on under the same account information.

18. The method according to claim 16, characterized in that, the method further comprises:
sending instruction information to the server for prompting the server to control the target electronic device to start the data reception mode;
receiving a confirmation instruction returned from the server, wherein the confirmation instruction is used for informing the first electronic device that the target electronic device starts the data reception mode;
sending data information to the server using the second communication channel built between the first electronic device and the server, so as to make the server send the data information to the target electronic device after receiving the data information and make the target electronic device output the data information.

19. The method according to claim 16, characterized in that, the method further comprises:
receiving a second control instruction sent by the server through the second communication channel, wherein the second control instruction is sent by the second electronic device to the server;
executing the second control instruction.

20. A first electronic device based on wireless login, characterized in that, the device comprises:
a memory having instructions stored thereon;
a processor configured to execute the instructions to perform remote controlling, comprising:
acquiring operation instruction;
judging whether the first electronic device is connected to a network;
detecting second electronic devices that are located in the same network as the first electronic device and meet a preset condition, when judging that the first electronic device is connected to the network;
determining at least one second electronic device as a target electronic device, when detecting the second electronic devices that meet the preset condition;
sending control instruction to the target electronic device, wherein the control instruction is used for controlling the target electronic device to execute the control instruction.

21. The first electronic device according to claim 20, characterized in that, the processor is further configured to perform:
judging whether the first electronic device is connected to a local area network, after an operation instruction is obtained;
detecting second electronic devices that are located in the same local area network as the first electronic device and meet a preset condition, when the first electronic device is connected to a local area network;
prompting the first electronic device whether to connect to the local area network when the first electronic device is not connected to the local area network;
receiving confirmation instruction to connect to the local area network;
connecting to the local area network after confirmation instruction to connect to the local area network is received;
wherein, to the processor is further configured to detect second electronic devices that are located in the same local area network as the first electronic device and meet a preset condition, after the first electronic device is connected to the local area network;
the processor is further configured to acquire the information of the second electronic devices that are located in the same local area network as the first electronic device and meet a preset condition; wherein the information of the second electronic device at least comprises the physical address of the second electronic device;
the processor is further configured to establish a first communication channel with the second electronic device according to the physical address of the second electronic device;
the processor is further configured to send control instruction to the second electronic device through the first communication channel, to control the second electronic devices to execute the control instruction.

22. The device according to claim 21, characterized in that,
the processor is further configured to pop up a second prompt message when it is unable to obtain the information of the second electronic devices that are located in the same local area network as the first electronic device and meet a preset condition within the preset time, wherein the second prompt message is configured to prompt the user to select whether to redetect the second electronic devices that are located in the same local area network as the first electronic device and meet a preset condition;
when the user selects to redetect the second electronic devices that are located in the same local area network as the first electronic device and meet a preset condition according to the second prompt message, the first electronic device redetects the second electronic devices that are located in the same local area network as the first electronic device and meet a preset condition.

23. The device according to claim 21, characterized in that, the processor is further configured to perform:
monitoring the connection state between the local area network and the first electronic device in real time;
popping up a third prompt message when the connection state between the local area network and the first electronic device is changed; the third prompt message being configured to prompt the user that the connection state between the local area network and the first electronic device is changed.

24. The device according to claim 20, characterized in that, the processor is further configured to perform:
judging whether the first electronic device is connected to the server;
sending account number information to the server, wherein the account information comprises the physical address of the first electronic device;
the physical address of the first electronic device being configured to build a first communication channel between the first electronic device and the server according to the physical address of the first electronic device, after the server receives the physical address of the first electronic device;
receiving the information of the second electronic devices that is sent by the server using the first communication channel and logs on to the server using the same account number information, wherein, the information of the second electronic device at least comprises the physical address of the second electronic device;
determining at least one of the second electronic devices that log on to the server as the target electronic device;
sending control information to the server, wherein the control information at least comprises the information of the target electronic device and the first control instruction;
wherein, the information of the target electronic device at least comprises the physical address of the target electronic device, wherein the physical address of the target electronic device is used for establishing a second communication channel between the target electronic device and the server according to the physical address of the target electronic device, after the server receives the physical address of the target electronic device, sending the first control instruction sent by the first electronic device to the target electronic device using the second communication channel, the first control instruction being used for executing the first control instruction after the target electronic device receives the first control instruction.

25. A first electronic device based on wireless login, characterized in that, the first electronic device comprises:
a memory having instructions stored thereon;
a processor configured to execute the instructions to perform remote controlling, comprising:
acquiring operation instruction;
judging whether the first electronic device is connected to a local area network, after acquiring operation instruction;
detecting second electronic devices that are located in the same local area network as the first electronic device and meet a preset condition, when judging that the first electronic device is connected to the local area network;
making the first electronic device log on to the server using account number, when judging that the first electronic device is not connected to the local area network;
detecting the second electronic devices that log on under the same account information as the first electronic device, after the user making the account log-in;
determining at least one second electronic device as the target electronic device among the second electronic devices located in the same network as the first electronic device and meet a preset condition; or among the second electronic devices located in the same network as the first electronic device
sending control instruction to the target electronic device, wherein the control instruction is used for controlling the target electronic device to execute the control instruction.

26. The first electronic device according to claim 25, characterized in that, the processor is further configured to perform:
sending account information to the server, wherein, the account information comprises the physical address of the first electronic device;
the physical address of the first electronic device being configured to establish the first communication channel between the first electronic device and the server according to the physical address of the first electronic device, after the server receives the physical address of the first electronic device,
receiving the information of the second electronic device that is sent by the server using the first communication channel and logs on to the server using the same account information; wherein, the information of the second electronic device at least comprises the physical address of the second electronic device;
determining at least one of the second electronic devices that log on to the server as the target electronic device;
sending control information to the server, wherein the control information at least comprises the information of the target electronic device and the first control instruction;
wherein, the information of the target electronic device comprises the physical address of the target electronic device, wherein the physical address of the target electronic device is used for establishing the second communication channel between the target electronic device and the server according to the physical address of the target electronic device, after the server receives the physical address of the target electronic device, sending the first control instruction sent by the first electronic device to the target electronic device using the second communication channel, the first control instruction is used for executing the first control instruction after the target electronic device receives the first control instruction.

27. A non-transitory computer readable medium, having computer programs stored thereon that, when executed by one or more processors of an electronic device, cause the electronic device to perform:
after obtaining an operation instruction, judging whether the first electronic device is connected to a network;
when judging that the first electronic device is connected to the network, detecting second electronic devices that are located in the same network as the first electronic device and meet a preset condition:
when detecting the second electronic devices that meet the preset condition, determining at least one second electronic device as a target electronic device; and
sending a control instruction to the target electronic device, wherein the control instruction is used for controlling the target electronic device to execute the control instruction.
